(19) United States
(12) Patent Application Publication
(10) Pub. No.: US 2002/0154717 A1
(43) Pub. Date: Oct. 24, 2002

(54) Weighting factor setting method for subtractive interference canceller, interference canceller unit using said weighting factor and interference canceller

(75) Inventors: Tetsufumi Shima, Yokosuka (JP); Jeonghoon Han, Yokosuka-shi (JP); Jonas Karlsson, Yokohama (JP)

Correspondence Address: Ronald L. Grudziecki, BURNS, DOANE, SWECKER & MATHIS, L.L.P., P.O. Box 1404, Alexandria, VA, 22313-1404, US

(73) Assignee: Telefonaktiebolaget LM Ericsson (publ), Stockholm (SE)

(21) Appl. No.: 10/020,887

(22) Filed: Dec. 19, 2001

(30) Foreign Application Priority Data
Dec. 19, 2000 (JP) 2000-385505

(51) Int. Cl. H04B 1/10

(52) U.S. Cl. 375/349

(57) ABSTRACT

The invention has the object of determining the optimum weighting coefficient for each channel in a subtractive interference canceller (IC). A weighting coefficient determining method in a subtractive interference canceller for handling digital radio communications, characterized in that complex weighting coefficients are set so as to minimize the power of an interference cancellation residual signal for each channel in each stage.

### TECHNICAL FIELD

The present invention relates primarily to a code division multiple access (CDMA) communication format in a cellular radio communication system, and particularly to a weighting factor determining method in a nonlinear subtractive interference canceller (IC) used as a technique for canceling multiple access interference (MAI) in CDMA.

### BACKGROUND ART

CDMA is a cellular radio communication format using a spread spectrum modulation technique wherein a specific code is assigned to communications with each user (normally, a pseudorandom code sequence, PN is used), channel separation is performed by spreading primary conversion data by the code on the transmission side, and despreading the received data with the same code on the receiving side to extract the primary conversion data.

While there is a possibility that the number of subscribers under the CDMA format will increase dramatically as compared with the frequency division multiple access (FDMA) format or the time division multiple access (TDMA) format due to its superior properties in terms of privacy, interference resistance and transmission path distortion, in order to achieve increased system capacity and high quality in CDMA to enable the handling of mobile multimedia communications, the demand for which is expected to surge in the future, technology capable of efficiently reducing multiple access interference (MAI) which is the major limiting factor for connection capacity in CDMA systems will be essential. As promising technologies in this respect, there are multi-user detectors, a typical example of which is the subtractive interference canceller (IC).

Multi-user detectors are an advanced means of eliminating multiple access interference which is the primary limiting factor for CDMA performance, to increase the number of users and expand the cell range in CDMA systems. For the theoretical background concerning multi-user detection, see for example S. Moshavi, “Multi-User Detection for DS-CDMA Communications”, IEEE Comm. Mag. 1996 and Sergio Verdu, Multiuser Detection, Cambridge University Press, 1998.

The subtractive interference canceller (hereinafter referred to simply as IC) is a technology for increasing the signal power to interference power ratio (SIR) with respect to the relevant user, by preparing a replica signal for each user based on an estimated complex reception fading envelope and decision data and subtracting the replica signals of other users from the received signal. Since IC's are capable of performing more effective interference cancellation by being constructed in multiple stages, they usually have a multi-stage structure. Additionally, IC's can be largely divided into parallel IC's which simultaneously perform replica preparation and subtraction for all users and serial IC's which sequentially perform replica preparation and subtraction for each user after sorting the signals in the order of magnitude of the received power, the basic structures and operations of each type being briefly explained below.

FIG. 1 shows the structure of a multi-stage parallel interference canceller (MSPIC). This MSPIC can handle K users and has an N-stage structure. Each stage comprises K interference canceller units ICU₁-ICU_{K} which are connected in parallel, a delay device (not shown, excluding the final stage), and an adder Σ (excluding the final stage). Here, the suffixes 1-K of the interference canceller units ICU₁-ICU_{K} correspond to the user numbers 1-K, and in the drawing, the area 101 bounded by the dashed line illustrates the first stage, 102 illustrates the second stage, and while the third and subsequent stages have been skipped, 103 illustrates the N-th, or final stage.

In the first stage, a received signal r₁ is inputted in parallel to the interference canceller unit ICU₁-ICU_{K} corresponding to each user. Here, the replica signals d₀⁽¹⁾-d₀^{(K)} are described as being inputted to the first stage for the purpose of consistency of expression, but the replica signals d₀⁽¹⁾-d₀^{(K)} inputted to the first stage are actually of value zero. The interference canceller units ICU₁-ICU_{K} in the first stage despread the received signals using the spreading code corresponding to the users, then perform symbol decisions and respreading to prepare replica signals d₁⁽¹⁾-d₁^{(K)}, which are then outputted to the interference canceller units ICU₁-ICU_{K} of the corresponding users in the second stage. Each interference canceller unit simultaneously outputs a replica signal to the adder Σ. At the adder Σ, replica signals corresponding to the respective users are subtracted as interference replicas from the received signal delayed by the time required for the procedures at the first stage, and the result is outputted to the second stage as an interference cancellation residual signal r₂.

The second stage has interference canceller units ICU₁-ICU_{K} and an adder Σ. When the interference cancellation residual signal r₂from the adder Σ of the first stage and the replica signals d₁⁽¹⁾-d₁⁽¹⁾ from the interference canceller units ICU₁-ICU_{K} of the first stage corresponding to the respective users have been inputted in parallel to the interference canceller units ICU₁-ICU_{K} of the second stage, the interference canceller units ICU₁-ICU_{K}, just as in the procedure for the first stage, despread the sum of the interference cancellation residual signal r₂and the replica signals d₁⁽¹⁾-d₁^{(K)} using the spreading code of the corresponding user, perform symbol decisions and respreading to prepare replica signals d₂⁽¹⁾-d₂^{(K)}, and output these to the interference canceller units ICU₁-ICU_{K} of the corresponding user in the third stage. Each interference canceller unit simultaneously outputs a second stage replica signal to the adder Σ. At the adder Σ, the second stage replica signal corresponding to each user is subtracted from the received signal r₁ delayed by the time required for the procedures of the second stage, and the result is outputted to the third stage as the interference cancellation residual signal r₃.

The structure of each stage from the third stage to the (N−1)-th stage is the same as the above-described structure of the second stage. The N-th stage, being the final stage, has neither a delay device nor an adder A, and is composed solely of interference canceller units ICU₁-ICU_{K}. After repeating procedures such as described above down to the (N−1)-th stage, at the N-th and final stage, the interference cancellation residual signal r_{N} and (N−1)-th stage replica signals d_{N-1}⁽¹⁾-d_{N-1}^{(K)} are inputted in parallel to the interference canceller units ICU₁-ICU_{K}, upon which interference canceller units ICU₁-ICU_{K} of the N-th stage despread the sum of the interference cancellation residual signal rN using the spreading code of the corresponding users, then perform symbol decisions and output the results as the replica signals d_{N}⁽¹⁾-d_{N}^{(K)}. The replica signals d_{N}⁽¹⁾-d_{N}^{(K)} corresponding to the respective users thus outputted from the final stage are modulated, thus obtaining data for each user.

Next, the processing performed in each interference canceller unit of the above-described multi-stage parallel interference canceller shall be described with reference to FIG. 2.

FIG. 2 shows the (s+1)-th stage interference canceller unit corresponding to user k. While omitted from the drawing, the interference canceller unit is composed of a plurality of path unit processing portions corresponding to multi-path propagation. The interference canceller unit ICU_{K} receives as inputs the interference cancellation residual signal rₛ₊₁ from the adder Σ of the previous, i.e. s-th stage, and a replica signal dₛ^{(k)} from the s-th stage interference canceller unit ICUₖ.

At the interference canceller unit ICUₖ, the inputted interference cancellation residual signal rₛ₊₁ and the replica signal dₛ^{(k)} from the previous stage are added by the adder 300, after which a despreading process using the user's spreading code cₖ* is performed on this sum signal by the despreader 302. On the other hand, at the transmission path estimating means 301, the propagation path fading vector is determined on the basis of the pilot signal in the sum signal. In the channel corrector 303, transmission path correction is performed using the complex conjugate of the transmission path fading vector. This signal corrected for the transmission path is combined with signals of other paths by means of a rake combiner not shown, and inputted to the decision making device 304. The decision making device 304 performs symbol decisions based on this signal, and outputs a symbol sequence. The structures of the channel corrector 303 and decision making device 304 are such as are conventionally known in CDMA communication systems, and their descriptions shall hence be omitted.

Next, the signal decoded into a symbol sequence by the decision making device 304 is respread at the respreader 305 using the spreading code c_{K} of the user, after which it is shaped (306) and inputted to the channel decorrector 307, where transmission path decorrection is performed using the transmission path fading vector to produce a replica signal. This replica signal subsequently undergoes a weighting procedure by multiplication of a weighting coefficient. Since this weighting coefficient is the subject of the present invention, it shall be described at length below.

The above-described multi-stage parallel interference canceller is distinguished from the multi-stage serial interference canceller to be described later by being capable of shortening the demodulation delay time.

Next, the structure of a multi-stage serial interference canceller (MSSIC) shall be described with reference to FIG. 3. This MSSIC, as with the above multi-stage parallel interference canceller (MSPIC), can handle K users and has an N-stage structure. Each stage has K serially connected interference canceller units ICU1-ICU_{K} and a delay device (not shown). Here, the subscripts 1-K of the interference canceller units ICU1-ICU_{K} correspond to user numbers 1-K, and in the drawing, the area bounded by the dashed line 201 illustrates a first stage, 202 illustrates a second stage, and with the third and subsequent stages being omitted, 203 illustrates the N-th or final stage. The multi-stage serial interference canceller (MSSIC) is generally used in conjunction with a sorting circuit, the sorting circuit being used to first to arrange the users in the order of magnitude of received power or based on some other criteria, so as to make the interference cancellation more efficient by performing interference cancellation according to the order of received power or the like at the interference canceller, but due to the fact that the sorting itself is not directly related to the present invention, its explanation shall be omitted here.

In the first stage of the multi-stage serial interference canceller (MSSIC), the received signal r₁⁽¹⁾ and a symbol replica which in the case of the first stage has the value zero are inputted to the interference canceller unit ICU₁ corresponding to the first user (e.g. the one with the highest received power). The fact that the replica signals d₀⁽¹⁾-d₀^{(K)} inputted to the first stage interference canceller units ICU₁-ICU_{K} all have the value zero is the same as in the above-described case of the multi-stage parallel interference canceller (MSPIC). The first interference canceller unit ICU₁ of the first stage sums the received signal r₁⁽¹⁾ and replica signal d₀⁽¹⁾, then despreads the received signal using the spreading code of the user (first user), after which it performs a symbol decision and respreading to produce the replica signal d₁⁽¹⁾ which is then outputted to the interference canceller unit ICU₁ of the corresponding user (first user) in the second stage. This interference canceller unit simultaneously subtracts the replica signal d₁⁽¹⁾ from the received signal, prepares a residual signal r₁⁽¹⁾ removing the first user signal having the highest power from the received signal, and outputs the result to the interference canceller unit ICU₂ of the second user.

At the interference canceller unit ICU₂, as in the above, the sum of the residual signal r₁⁽²⁾ and replica signal d₀⁽²⁾ is despread using the spreading code of the corresponding user (second user), then a symbol decision and respreading are performed to produce a replica signal d₁⁽²⁾ which is then outputted to the interference canceller unit ICU₂ of the corresponding user (second user) in the second stage. This interference canceller unit simultaneously further subtracts the replica signal d₁⁽²⁾ of the second user from the signal r₁⁽²⁾ delayed by the processing time to produce a signal r₁⁽³⁾ with the first and second user signals with high power removed, and outputs the result to the interference canceller unit ICU₃ corresponding to the third user.

At the interference canceller units ICU₃-ICU_{K-1}, procedures such as those descried above are sequentially repeated and the results outputted to the interference canceller units ICU₃-ICU_{K-1} of the user corresponding to the second stage, while simultaneously the respective replica signals are further subtracted from the signals r₁⁽³⁾-r₁^{(K-1)} delayed by the processing time and a signal r₁^{(K)} with the user signals removed in the order of the magnitude of the power up to the (K−1)-th is produced, this being then outputted to the interference canceller unit ICU_{K} corresponding to the K-th user.

At the interference canceller unit ICU_{K}, as above, the signal r₁^{(K)} is despread using the spreading code of the corresponding user (K-th user), and symbol decision and respreading are performed to prepare a replica signal d₁^{(K)} which is then outputted to the interference canceller unit ICU_{K} of the corresponding user (K-th user) in the second stage. This interference canceller unit simultaneously further subtracts the replica signal d₁^{(K)} of the K-th user from the signal r₁^{(K)} delayed by the processing time to produce an interference cancellation residual signal r₂⁽¹⁾ with the replica signals of all users from the first through N-th users subtracted from the received signal, which is then outputted to the interference canceller unit ICU₁ corresponding to the first user in the second stage.

In the interference canceller units ICU₁-ICU_{K} of the second stage, the same procedures as in the interference canceller units ICU₁-ICU_{K} of the first stage are performed aside from the fact that the residual signal r₂⁽¹⁾ is used instead of the received signal r₁⁽¹⁾, and they respectively output replica signals d₂⁽¹⁾-d₂^{(K)} of the second stage to the interference canceller units ICU₃-ICU_{K} of the third stage. At the same time, they output residual signals with their own replica signals subtracted to the next interference canceller units.

Thereafter, the process proceeds in the same manner down to the N-th stage. While the procedures at the interference canceller units ICU₁-ICU_{K} of the N-th stage are basically the same as in the previous stages, they differ in that tentative decision symbols are outputted as replica signals.

FIG. 4 shows the (s+1)-th interference canceller unit corresponding to user k of the interference canceller units forming the multi-stage serial interference canceller (MSSIC) shown in FIG. 3. While not shown in the drawing, the interference canceller unit is the same as the interference canceller unit of the multi-stage parallel interference canceller (MSPIC) shown in FIG. 3 with regard to being composed of a plurality of path unit processing portions for handling multi-path propagation. Since the interference canceller units have most of their parts in common, an explanation shall be given primarily with respect to only the differences.

In the interference canceller unit ICUk shown in FIG. 4, the residual signal rₛ₊₁^{k} from the interference canceller unit ICUₖ₋₁ corresponding to the user (k−1) and the replica signal dₛ^{k} from the interference canceller unit ICUₖ of the s-th stage are added at the adder 400, and as in the interference canceller unit shown in FIG. 2, despreading (402), calculation of the transmission path fading vector (401) and transmission path correction (403) are performed, and after rake combination (not shown), the result is decoded into a symbol sequence by the decision making device 404. At the decision making device 404, the signal is decoded into a symbol sequence, and after respreading (405) using the spreading code cₖ of the user, is shaped (406), transmission path corrected (407) and weighted to produce a replica signal dₛ₊₁^{k} for each path.

The difference between the interference canceller unit shown in FIG. 4 and the interference canceller unit shown in FIG. 2 is that the new replica signal dₛ₊₁^{k} is resubtracted from the results of the above-mentioned addition of the residual signal rₛ₊₁^{k} and the replica signal dₛ^{k} to produce an error signal rₛ₊₁^{k+1}, and sent to the interference cancellation unit ICU_{K+1} corresponding to the next user.

The above-described serial multi-stage subtractive interference canceller, while generally capable of achieving efficient interference cancellation with a small number of stages, has the characteristic of having a comparatively long delay time.

FIG. 5 is a drawing showing the multi-path handling structure of the interference canceller unit. While not essential, interference canceller units are normally structure so as to be able to handle multi-path propagation, in which case the structure will be as shown in FIG. 5. As shown in FIG. 5, a residual signal rₛ^{k} and a replica signal dₛ^{k} for each path is inputted to the interference canceller unit, after performing despreading (501) and calculation of the fading vector (502) for each path, the symbols of all paths are combined by a rake (503). After performing a symbol decision (504), respreading (505) and transmission path decorrection (506) are performed by the path, followed by multiplication of weighting coefficients (507) to produce replica signals for each path which are then outputted to the interference canceller unit of the next stage.

Next, the weighting coefficients shall be described.

While the overall performance of a subtractive IC will depend on the precision of formation of replicas, errors will inevitably be included in the created replicas due to the presence of errors in channel estimation and tentative decisions. One way to improve performance of a subtractive IC by reducing errors in the replicas and from the viewpoint of probability theory, reducing inaccuracies in replica generation is to employ weighting coefficients. For more on weighting theory, see for example D. Divsalar, “Improved Parallel Interference Cancellation for CDMA”, IEEE Trans. Commun. vol. 46, No. 2, February 1998, pp. 258-268; T. Suzuki, “Near-Decorrelating Multistage Detector for Asynchronous DS-CDMA”. IEICE Trans. Commun. vol. E81-B No. 3, March 1998, pp. 553-564; and Louis G. F. Trichard, “Parameter Selection for Multiuse Receivers Based on Partial Parallel Interference Cancellation”, Proceedings of VTC 00 in Japan.

Additionally, since subtractive IC's have a shorter delay time than other IC's, they are believed to be most suited to parallel IC's (PIC), but without weighting coefficients, PIC's are not necessarily superior in performance compared to other IC's, so that particularly for applications to PIC's, there is a need for a good algorithm for determining weighting factors. Conventional methods for determining weighting coefficients are described, for example, in K. Higuchi and F. Adachi, “Laboratory Experiments on Coherent Multistage Interference Canceller Using Interference Rejection Weight Control for DS-CDMA Mobile Radio”, IEICE RCS99-29, July 1999, pp. 25-30; D. Divsalar, “Parallel Interference Cancellation for CDMA Applications”, U.S. Pat. No. 5,644,593, 1 July 1997; D. Divsalar, “Improved Parallel Interference Cancellation for CDMA”, IEEE Trans. Commun. vol. 46, No. 2, February 1998, pp. 258-268; T. Suzuki, “Near-Decorrelating Multistage Detector for Asynchronous DS-CDMA”, IEICE Trans. Commun. vol. E81-B No. 3, March 1998, pp. 553-564; Japanese Patent Application, First Publication No. H11-298371 and Japanese Patent No. 2967571.

Here, weighting methods according to the conventional art shall be explained by example of Japanese Patent Application, First Publication No. H11-298371 and Japanese Patent No. 2967571.

The conventional art disclosed in Japanese Patent Application, First Publication No. H11-298371 has the object of ultimately improving the interference cancellation properties by multiplying weighting coefficients by the path in each interference cancelling unit, and is a method of applying small weighting coefficients to the opening stages which have a large decision symbol error to ease the interference cancellation operation and control the interference cancellation errors due thereto, while on the other hand applying comparatively large weighting coefficients to the latter stages which have smaller transmission path estimation errors and decision symbol errors, thus distributing the interference cancellation ability.

According to this prior art specification, the interference cancellation unit comprises a plurality of path unit processing portions corresponding to multi-path propagation forming a plurality of paths; despreading means which receives as input an interference cancellation residual signal of the (s−1)-th stage for performing despreading in path units; a first adder for adding to the output thereof a signal obtained by performing a first weighting on the symbol replica of the (s−1)-th stage in path units; a detector for modulating the output thereof using transmission path estimation values in path units; a second adder for combining the outputs corresponding to the respective paths of said detector; a decision making device for symbol decision making of the output thereof; a multiplier for multiplying said transmission path estimation values with the output of the decision making device in path units to produce a symbol replica in path units of the s-th stage; a subtrador for subtracting from this output a signal obtained by performing the first weighting on the symbol replica of the (s−1)-th stage in path units; spreading means for spreading the output of the subtractor in path units; and a third adder for combining the outputs of said spreading means corresponding to each path.

The s-th stage weighting coefficient in the above-described prior art is proposed to be 1, 1−(1−α)ₛ₋₁, α, 1−(1−αβₙ₁) or αβₙₘ₋₁ (α and β being respectively real number less than or equal to 1).

On the other hand, the art disclosed in Japanese Patent No. 2967571 is a method for changing the weighting coefficient according to the SIR (signal power to interference power ratio). According to this method, the interference canceller comprises an SIR measuring portion and weighting coefficient calculating portion (called in the patent specification a “suppression coefficient control portion”) for each user, the SIR measuring portion measuring the SIR which represents the reception quality of the desired user signal after despreading using a known pilot symbol (the SIR is determined by computing the overall power of the known signal portion after despreading with the power of the signal with averaged noise by in-phase addition of known signal portions after despreading), and based thereon, making the weighting coefficient al if the SIR is at least a predetermined value m₁, making the weighting coefficient α₂ if the SIR is at least a predetermined value m₂ and less than m₁, and making the weighting coefficient α₃ if the SIR is less than m₂. Here, 0<α₃<α²<α₁<1. That is, the weighting coefficient, while different for each user, is a real number between 0 and 1 which is the same for all stages when considered separately for each user.

As is dear from the above-described example, conventional weighting coefficients are such as to use predetermined values, or to use the same weighting coefficient for all stages, albeit based on the signal-to-interference ratio (SIR) of the received signal of each user. Therefore, they cannot be considered to be performing the optimum weighting for each channel and user. As mentioned above, in subtractive IC's, the weighting procedure plays a crucial role in reducing inaccuracies in the replicas. In order to reduce inaccuracies in replicas, it is desirable to optimally switch the weighting coefficient for each channel, user and stage. Additionally, all of the weighting coefficients used in conventional methods are real numbers, and as a result, they adjust only the amplitude of the replica signals, this being insufficient.

### DISCLOSURE OF THE INVENTION

In consideration of the above situation, the present invention has the object of offering a method for determining the optimum weighting coefficients in a subtractive interference canceller (IC).

According to the first aspect of the present invention, the present invention proposes a weighting coefficient determining method in a subtractive interference canceller for digital radio communications wherein the communication channel is composed of pilot bits, other control bits and data bits;

the weighting coefficient determining method being characterized in that the weighting coefficient λ_{A}^{Q} of the pilots bits, the weighting coefficient λ_{B}^{Q} of the other control bits and the weighting coefficient λ^{I} of the data bits are mutually independent values.

The above-described first method makes use of the fact that the properties and magnitude of estimation errors differs according to the bit group such that whereas errors are contained in the estimations of data bits and other control bits, a bit error does not in principle occur in the pilot bits due to their being known on the receiving side, hence improving the interference cancellation precision by making the weighting coefficients λ_{A}^{Q}, λ_{B}^{Q} and λ^{I} of the respective groups independent and thereby reflecting the properties and magnitude of the errors for each group in the weighting coefficients.

The present invention also proposes a second method wherein, in the aforementioned first weighting coefficient determining method, said weighting coefficients λ_{A}^{Q}, λ_{B}^{Q} and λ^{I} are determined for each user and stage based on a tentative decision symbol and an average or instantaneous signal-to-interference ratio SIR.

According to the results of evaluations which will be described in detail in the following examples, it is shown that the weighting coefficients can be determined separately by the user and stage by providing a tentative decision symbol and a (average or instantaneous) signal-to-interference ratio SIR. Since the weighting coefficient changes according to the user and stage, it is possible to accurately reflect the influence of differing powers and paths according to the user and the concentration of interference cancellation due to repetition.

The present invention also proposes a third weighting coefficient determining method wherein, in the aforementioned second method, signal-to-interference ratios SIR_{I} and SIR_{Q} respectively of an I branch and a Q branch are used as the signal-to-interference ratio SIR, and the weighting coefficients λ^{I} and λ^{Q} of the I branch and Q branch are derived from tentative decision symbol and a tentative decision error probability density function derived from the signal-to-interference ratios SIR_{I} and SIR_{Q}.

According to the results of evaluations which shall be described in detail in the following examples, it is shown that it is possible to set weighting coefficients λ_{I} and λ_{Q} of the I branch and Q branch using the signal-to-interference power ratios SIR_{I} and SIR_{Q} of the I branch and Q branch respectively as the SIR.

The present invention also proposes a fourth weighting coefficient determining method based on the second aspect of the present invention, characterized in that the weighting coefficients are set so as to minimize the power of the interference cancellation residual signal for each channel in each stage.

According to this fourth method, the power of the interference cancellation residual signal for each channel is taken as an evaluation function, and a complex weighting coefficient which minimizes the value of this evaluation function is set for each user, path and stage, thus enabling the interference to be most effectively removed by means of each interference cancellation process. In this case, when the weighting coefficient is made a complex number, weighting which considers the phase components as well as the amplitude components is performed, thereby improving the interference cancellation precision.

The present invention also proposes a fifth weighting coefficient determining method wherein, in the aforementioned fourth method, said weighting coefficients are derived based on the relationship expressed by the following equation:

$${λ}_{k , l}^{s} ( {H}_{k , l}^{s} , {B}_{k}^{s} ) = \frac{\int ⅆ {h}_{k , l} \int ⅆ {b}_{k} {h}_{k , l} {b}_{k} f ( {h}_{k , l} , {H}_{k , l}^{s} , {b}_{k} , {B}_{k}^{s} )}{{H}_{k , l}^{s} {B}_{k}^{s}} \qquad [ Eq . 1 ]$$

Wherein λ_{k,l}^{S} denotes the weighting coefficient of the l-th path for the k-th user in the s-th stage;

H_{k,l}^{S} denotes the estimated channel of the l-th path for the k-th user in the s-th stage;

Bₖ^{S} denotes the tentative decision symbol of the k-th user in the s-th stage;

h^{k,l}(t) denotes the channel coefficient of the l-th path for the k-th user;

bₖ denotes the signal received by the k-th user; and

f(h_{k,l}, H_{k,l}^{S}, bₖ, Bₖ^{S}) is a combined tentative decision error probability density function relating to the channel coefficient h_{k,l}, the estimated channel H_{k,l}, the received signal bₖ and the tentative decision symbol Bₖ^{S}.

As is indicated in the following description of the examples, the use of the above-given relationship enables the weighting coefficient to be specifically set so as to minimize the power of the above-mentioned interference cancellation residual signal.

The present invention also proposes a sixth weighting coefficient determining method wherein, in the aforementioned fifth method, said weighting coefficients are approximated as follows:

$${λ}_{k , l}^{s} ( {H}_{k , l}^{s} , {B}_{k}^{s} ) ≅ \frac{\int ⅆ {b}_{k} {b}_{k} f ( {h}_{k , l} , {H}_{k , l}^{s} , {b}_{k} , {B}_{k}^{s} )}{{B}_{k}^{s}} \qquad [ Eq . 2 ]$$

By approximating the earlier relationship by the above equation, the process of derivation of the weighting coefficient can be considerably simplified without substantially sacrificing the interference cancellation precision.

The present invention also proposes a weighting coefficient determining method wherein, in the aforementioned sixth method, the weighting coefficients are further determined by taking the received signal bₖ as follows:

bₖ=Aₖ^{S}e^{iφ}^{ₖ}^{^{s}} [Eq. 3]

And using the following relationship:

$$\begin{matrix}\frac{\int ⅆ {b}_{k} {b}_{k} f ( {h}_{k , l} , {H}_{k , l}^{s} , {b}_{k} , {B}_{k}^{s} )}{{B}_{k}^{s}} = \int ⅆ {b}_{k} {A}_{k}^{s} {ⅇ}^{{ⅈϕ}_{k}^{s}} f ( {h}_{k , l} , {H}_{k , l}^{s} , {b}_{k} , {B}_{k}^{s} ) \\ = f ( {h}_{k , l} , {H}_{k , l}^{s} , {B}_{k}^{s} , {B}_{k}^{s} ) + \\ f ( {h}_{k , l} , {H}_{k , l}^{s} , {ⅇ}^{{ⅈϕ}_{I}} {B}_{k}^{s} , {B}_{k}^{s} ) {ⅇ}^{{ⅈϕ}_{J}} + \\ f ( {h}_{k , l} , {H}_{k , l}^{s} , {ⅇ}^{{ⅈϕ}_{Q}} {B}_{k}^{s} , {B}_{k}^{s} ) {ⅇ}^{{ⅈϕ}_{Q}} - \\ f ( {h}_{k , l} , {H}_{k , l}^{s} , {ⅇ}^{i π} {B}_{k}^{s} , {B}_{k}^{s} )\end{matrix} \qquad [ Eq . 4 ]$$

Wherein φ_{I} and φ_{Q} are phase errors when only the I or Q phase contains measurement errors, and are expressed as follows:

$$\begin{matrix}{ϕ}_{I} = sgn ( real ( {B}_{k}^{s} ) ) sgn ( imag ( {B}_{k}^{s} ) ) 2 ( \frac{π}{2} - a tan \vert \frac{imag ( {B}_{k}^{s} )}{real ( {B}_{k}^{s} )} \vert ) \\ {ϕ}_{Q} = - sgn ( real ( {B}_{k}^{s} ) ) sgn ( imag ( {B}_{k}^{s} ) ) 2 a tan \vert \frac{imag ( {B}_{k}^{s} )}{real ( {B}_{k}^{s} )} \vert\end{matrix} \qquad [ Eq . 5 ]$$

Furthermore, the terms on the righthand side of Equation 4, using the signal-to-interference ratio SIR_{I(Q)} of the I(Q) branch and the tentative decision error probability of the I(Q) branch:

$$g ( {SIR}_{I ( Q )} \vert {h}_{k , l} , {H}_{k , l}^{s} , {b}_{k} , {B}_{k}^{s} ) = \frac{1}{\sqrt{2 π}} {{{\int }^{∞} ⅇ}_{\sqrt{{SIR}_{I ( Q )}}}}^{- \frac{{x}^{2}}{2}} ⅆ x \qquad [ Eq . 6 ]$$

Are expressed as follows:

$$f ( {h}_{k , l} , {H}_{k , l}^{s} , {B}_{k}^{s} , {B}_{k}^{s} ) = ( 1 - g ( {SIR}_{I} \vert {h}_{k , l} , {H}_{k , l}^{s} , {b}_{k} , {B}_{k}^{s} ) ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{i}} , {B}_{k}^{s} ) = g ( {SIR}_{I} \vert {h}_{k , l} , {H}_{k , l}^{s} , {b}_{k} , {B}_{k}^{s} ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{Q}} , {B}_{k}^{s} ) = ( 1 - g ( {SIR}_{I} \vert {h}_{k , l} , {H}_{k , l}^{s} , {b}_{k} , {B}_{k}^{s} ) ) g ( {SIR}_{Q} \vert {h}_{k , l} , {H}_{k , l}^{s} , {b}_{k} , {B}_{k}^{s} ) \\ f ( {h}_{k , l} , {H}_{k , l}^{s} , - {B}_{k}^{s} , {B}_{k}^{s} ) = g ( {SIR}_{I} \vert {h}_{k , l} , {H}_{k , l}^{s} , {b}_{k} , {B}_{k}^{s} ) g ( {SIR}_{Q} \vert {h}_{k , l} , {H}_{k , l}^{s} , {b}_{k} , {B}_{k}^{s} ) \qquad [ Eq . 7 ]$$

The present invention also discloses a seventh weighting coefficient determining method wherein, in the aforementioned seventh method, φ_{I} and φ_{Q} are calculated according to the following:

φ_{I}=π−2a tan (β) [Eq. 8]

φ_{Q}=2a tan (β) [Eq. 9]

Wherein β in the equations is a value calculated based on a power ratio γ between the I and Q branches expressed by the following equation:

$$β = \frac{1}{\sqrt{γ}}$$

The present invention also proposes a ninth weighting coefficient determining method wherein, in the method according to any one of the aforementioned first through eighth methods, wherein the digital radio communications are code division multiple access (CDMA) communications.

While the object of application of the present method is not restricted to the CDMA format, the CDMA format can be given as an example of a digital radio communication format.

The present invention also proposes a first interference canceller unit which is an interference canceller unit in a subtractive interference canceller for digital radio communications wherein the communication channel is composed of pilot bits, other control bits and data bits; characterized by comprising

adding means (300, 400) for receiving and adding an interference cancellation residual signal and a replica signal from a previous stage;

despreading means (302, 402) for despreading the aforementioned addition signal by multiplying a spreading code of the user;

correcting means (301, 303, 401, 403) for determining a fading vector and performing transmission path correction;

tentative decision means (304, 404) for deciding on a symbol from the transmission path corrected signal;

weighting means (308, 408) for multiplying a weighting coefficient to the tentative decision symbol;

spreading means (305, 405) for respreading the tentative decision symbol by multiplying the spreading code of the user; and

decorrecting means (307,407) for determining a replica signal by multiplying the inverse of the transmission path properties to the respread signal; and

in that said weighting means outputs a weighting coefficient λ_{A}^{Q} of the pilots bits, a weighting coefficient λ_{B}^{Q} of the other control bits and a weighting coefficient λ^{I} of the data bits as separately derived values.

With the above-given first interference canceller unit which is an example of a structure for realizing the first method, it is possible to obtain the effects described with respect to the first method.

The present invention also proposes a second interference canceller unit wherein, in the aforementioned first interference canceller unit, the weighting means determines said weighting coefficients λ_{A}^{Q}, λ_{B}^{Q} and λ^{I} for each user and stage based on a tentative decision symbol and an average or instantaneous signal-to-interference ratio SIR.

With the above-given second interference canceller unit which is an example of a structure for realizing the second method, it is possible to obtain the effects described with respect to the second method.

The present invention also proposes a third interference canceller unit wherein, in the aforementioned second interference canceller unit, the weighting means derives the weighting coefficients λ^{I} and λ^{Q} of the I branch and Q branch from a tentative decision symbol and a tentative decision error probability density function derived from the signal-to-interference ratios SIR_{I} and SIR_{Q}.

With the above-given third interference canceller unit which is an example of a structure for realizing the third method, it is possible to obtain the effects described with respect to the third method.

The present invention also proposes a fourth interference canceller unit which is an interference canceller unit in a subtractive interference canceller for digital radio communications; characterized by comprising

adding means (300, 400) for receiving and adding an interference cancellation residual signal and a replica signal from a previous stage;

despreading means (302, 402) for despreading the aforementioned addition signal by multiplying a spreading code of the user;

correcting means (301, 303, 401, 403) for determining a fading vector and performing transmission path correction;

tentative decision means (304, 404) for deciding on a symbol from the transmission path corrected signal;

weighting means (308, 408) for multiplying a weighting coefficient to the tentative decision symbol;

spreading means (305, 405) for respreading the tentative decision symbol by multiplying the spreading code of the user; and

decorrecting means (307, 407) for determining a replica signal by multiplying the inverse of the transmission path properties to the respread signal; and

in that said weighting means determines a complex weighting coefficient such as to minimize the power of the interference cancellation residual signal for each channel in each stage.

With the above-given fifth interference canceller unit which is an example of a structure for realizing the fourth method, it is possible to obtain the effects described with respect to the fourth method.

The present invention also proposes a fifth interference canceller unit wherein, in the aforementioned fourth interference canceller unit, the weighting coefficients are derived based on the relationship expressed by the following equation:

$${λ}_{k , l}^{s} ( {H}_{k , l}^{s} , {B}_{k}^{s} ) = \frac{\int ⅆ {h}_{k , l} \int ⅆ {b}_{k} {h}_{k , l} {b}_{k} f ( {h}_{k , l} , {H}_{k , l}^{s} , {b}_{k} , {B}_{k}^{s} )}{{H}_{k , l}^{s} {B}_{k}^{s}} \qquad [ Eq . 11 ]$$

Wherein λ_{k,l}^{S} denotes the weighting coefficient of the l-th path for the k-th user in the s-th stage;

H_{k,l}^{S} denotes the estimated channel of the l-th path for the k-th user in the s-th stage;

Bₖ^{S} denotes the tentative decision symbol of the k-th user in the s-th stage;

h_{k,l}(t) denotes the channel coefficient of the l-th path for the k-th user;

bₖ denotes the signal received by the k-th user; and

f(h_{k,l}, H_{k,l}, bₖ, Bₖ^{S}) is a combined tentative decision error probability density function relating to the channel coefficient h_{k,l}, the estimated channel H_{k,l}, the received signal bₖ and the tentative decision symbol Bₖ^{S}.

With the above-given sixth interference canceller unit which is an example of a structure for realizing the sixth method, it is possible to obtain the effects described with respect to the sixth method.

The present invention also proposes a sixth interference canceller unit wherein, in the aforementioned fifth interference canceller unit, the weighting coefficients are approximated as follows:

$${λ}_{k , l}^{s} ( {H}_{k , l}^{s} , {B}_{k}^{s} ) ≅ \frac{\int ⅆ {b}_{k} {b}_{k} f ( {h}_{k , l} , {H}_{k , l}^{s} , {b}_{k} , {B}_{k}^{s} )}{{B}_{k}^{s}} \qquad [ Eq . 12 ]$$

With the above-given sixth interference canceller unit which is an example of a structure for realizing the sixth method, it is possible to obtain the effects described with respect to the sixth method.

The present invention also proposes a seventh interference canceller unit wherein, in the aforementioned sixth interference canceller unit, the weighting coefficients are further determined by taking the received signal bk as follows:

$${b}_{k} = {A}_{k}^{s} {ⅇ}^{{jϕ}_{k}^{s}} \qquad [ Eq . 13 ]$$

And using the following relationship:

$$\begin{matrix}\frac{\int ⅆ {b}_{k} {b}_{k} f ( {h}_{k , l} {H}_{k , l}^{s} , {b}_{k} , {B}_{k}^{s} )}{{B}_{k}^{s}} = \int ⅆ {b}_{k} {A}_{k}^{s} {ⅇ}^{{ⅈϕ}_{k}^{s}} f ( {h}_{k , l} , {H}_{k , l}^{s} , {b}_{k} , {B}_{k}^{s} ) \\ = f ( {h}_{k , l} , {H}_{k , l}^{s} , {B}_{k}^{s} , {B}_{k}^{s} ) + \\ f ( {h}_{k , l} , {H}_{k , l}^{s} , {ⅇ}^{{ⅈϕ}_{I}} {B}_{k}^{s} , {B}_{k}^{s} ) {ⅇ}^{{ⅈϕ}_{I}} + \\ f ( {h}_{k , l} , {H}_{k , l}^{s} , {ⅇ}^{{ⅈϕ}_{Q}} {B}_{k}^{s} , {B}_{k}^{s} ) {ⅇ}^{{ⅈϕ}_{Q}} - \\ f ( {h}_{k , l} , {H}_{k , l}^{s} , {ⅇ}^{ⅈπ} {B}_{k}^{s} , {B}_{k}^{s} )\end{matrix} \qquad [ Eq . 14 ]$$

Here, φ_{I} and φ_{Q} are phase errors when only the I or Q phase contains measurement errors, and are expressed as follows:

$$\begin{matrix}{ϕ}_{I} = sgn ( real ( {B}_{k}^{s} ) ) sgn ( imag ( {B}_{k}^{s} ) ) 2 ( \frac{π}{2} - a tan \vert \frac{imag ( {B}_{k}^{s} )}{real ( {B}_{k}^{s} )} \vert ) \\ {ϕ}_{Q} = - sgn ( real ( {B}_{k}^{s} ) ) sgn ( imag ( {B}_{k}^{s} ) ) 2 a tan \vert \frac{imag ( {B}_{k}^{s} )}{real ( {B}_{k}^{s} )} \vert\end{matrix} \qquad [ Eq . 15 ]$$

Furthermore, the terms on the righthand side of Equation 14, using the signal-to-interference ratio SIR_{I(Q)} of the I(Q) branch and the tentative decision error probability of the I(Q) branch:

$$g ( {SIR}_{I ( Q )} \vert {h}_{k , l} , {H}_{k , l}^{s} , {b}_{k} , {B}_{k}^{s} ) = \frac{1}{\sqrt{2 π}} {{\int }^{∞} {ⅇ}^{- \frac{{x}^{2}}{2}}}_{\sqrt{{SIR}_{I ( Q )}}} ⅆ x \qquad [ Eq . 16 ]$$

Are expressed as follows:

$$f ( {h}_{k , l} , {H}_{k , l}^{s} , {B}_{k}^{s} , {B}_{k}^{s} ) = ( 1 - g ( {SIR}_{I} \vert {h}_{k , l} , {H}_{k , l}^{s} , {b}_{k} , {B}_{k}^{s} ) ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{I}} , {B}_{k}^{s} ) = g ( {SIR}_{I} \vert {h}_{k , l} , {H}_{k , l}^{s} , {b}_{k} , {B}_{k}^{s} ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{Q}} , {B}_{k}^{s} ) = ( 1 - g ( {SIR}_{I} \vert {h}_{k , l} , {H}_{k , l}^{s} , {b}_{k} , {B}_{k}^{s} ) ) g ( {SIR}_{Q} \vert {h}_{k , l} , {H}_{k , l}^{s} , {b}_{k} , {B}_{k}^{s} ) \\ f ( {h}_{k , l} , {H}_{k , l}^{s} , - {B}_{k}^{s} , {B}_{k}^{s} ) = g ( {SIR}_{I} \vert {h}_{k , l} , {H}_{k , l}^{s} , {b}_{k} , {B}_{k}^{s} ) g ( {SIR}_{Q} \vert {h}_{k , l} , {H}_{k , l}^{s} , {b}_{k} , {B}_{k}^{s} ) \qquad [ Eq . 17 ]$$

The present invention also proposes an eighth interference canceller unit wherein said φ_{I} and φ_{Q} are calculated according to the following:

φ_{I}=π−2a tan (β) [Eq. 18]

φ_{Q}=2a tan(β) [Eq. 19]

Wherein β in the equations is a value calculated based on a power ratio γ between the I and Q branches expressed by the following equation:

$$β = \frac{1}{\sqrt{γ}} \qquad [ Eq . 20 ]$$

The present invention also proposes the first through eighth interference canceller units wherein the digital radio communications are code division multiple access (CDMA) communications.

With the above-given ninth interference canceller unit which is an example of a structure for realizing the ninth method, it is possible to obtain the effects described with respect to the ninth method.

The present invention also proposes a parallel subtractive interference canceller characterized by comprising a plurality of processing stages composed of a plurality of interference canceller units for handling a plurality of users, each stage aside from the final stage further comprising an adder; wherein

a replica signal is prepared by inputting a received signal and a zero value to each interference canceller unit in the first stage, and outputted to said adder and each interference canceller unit of the corresponding user in the next stage;

a replica signal for each stage from the second stage to the next-to-last stage is prepared by inputting the interference cancellation residual signal in the previous stage and said replica signal of the previous stage to each interference canceller unit, and outputted to said adder and each interference canceller unit of the corresponding user in the next stage; and

a replica signal is prepared in each interference canceller unit of the final stage by inputting the interference cancellation residual signal of the previous stage and said replica signal of the previous stage, and outputted; and

wherein as said interference canceller unit, one as recited in any one of the first through ninth interference canceller units is used.

According to this parallel subtractive interference canceller, the aforementioned effects described with regard to the first through ninth interference canceller units can be obtained, thus achieving a high-precision interference cancellation.

The present invention also proposes a serial subtractive interference canceller comprising a plurality of stages composed of a plurality of interference canceller units for handling a plurality of users; wherein

a replica signal is prepared by inputting a received signal and a zero value to the interference canceller unit of the first user in the first stage and outputted to the interference canceller unit of the corresponding user in the next stage, and the replica signal is subtracted from the received signal and the result is outputted to the interference canceller unit of the second user;

a replica signal is prepared by inputting a signal subtracting replica signals from the first through previous users from the received signal and a zero value to the interference canceller unit of the second and subsequent users of the first stage, outputted to the interference canceller unit of the corresponding user in the next stage, and the replica signal is subtracted from the received signal and the result outputted to the interference canceller unit of the next user;

a replica signal is prepared by inputting an interference cancellation residual signal of the first stage instead of the received signal and the replica signal from the previous stage instead of a zero value to the interference canceller unit of the first user in the second stage, and outputted to the interference canceller unit of the corresponding user in the next stage, and the replica signal is subtracted from the received signal and the result outputted to the interference canceller unit of the second user; and

a replica signal is prepared and outputted by performing the same procedure until the final stage; and

wherein as said interference canceller unit, one as per any one of the aforementioned first through ninth interference canceller units is used.

According to this serial subtractive interference canceller, the aforementioned effects described with regard to the first through ninth interference canceller units can be obtained, thus achieving a high-precision interference cancellation.

### BRIEF DESCRIPTION OF THE DRAWINGS

FIG. 1 shows the structure of a multi-stage parallel interference canceller (MSPIC).

FIG. 2 shows the structure of an interference canceller unit (ICU) forming the multi-stage parallel interference canceller.

FIG. 3 shows the structure of a multi-stage serial interference canceller (MSSIC).

FIG. 4 shows the structure of an interference canceller unit (ICU) forming the multi-stage serial interference canceller.

FIG. 5 is a diagram showing the structure of an interference canceller unit assuming multi-path propagation.

FIG. 6 is a channel structure diagram showing the structure of a dedicated physical control channel and a dedicated physical data channel.

FIG. 7 is a functional diagram showing the structure of an interference canceller unit based on the present invention.

FIG. 8 is a functional diagram showing the structure of a probability density calculating portion of a weighting coefficient calculating module based on the present invention.

FIG. 9 is a functional diagram showing the structure of a weighting coefficient generator of a weighting coefficient calculating module based on the present invention.

FIG. 10 is a functional diagram showing the structure of an interference canceller unit based on the present invention.

FIG. 11 is a functional diagram showing the structure of a weighting coefficient generator of a weighting coefficient calculating module based on the present invention.

### MODES FOR CARRYING OUT THE INVENTION

The technical background of the weighting coefficient determining method, interference canceller unit and interference canceller according to a first aspect of the present invention shall be explained below.

FIG. 6 shows an example of the structure of a W-CDMA radio slot. In the W-CDMA format, two dedicated physical channels (DPCH) are used. One is a dedicated physical control channel (DPCCH) mapped onto the Q channel of an I/Q channel, and the other is a dedicated physical data channel (DPDCH) mapped onto the I channel of the I/Q channel. The dedicated physical control channel contains a pilot bit (Nₚ) and other control bits including a TFCI bit, an FBI bit and a TPC bit. On the other hand, the dedicated physical data channel is entirely composed of only data bits.

In a weighting coefficient determining method of the conventional art, a single weighting coefficient is set regardless of the channel, and the concept of using a different weighting coefficient according to the bit group (e.g. pilot bit group, other control bit group and data bit group) does not exist. However, the causes of errors and the probability of error is not the same for each bit group.

That is, since the pilot bit is known at the reception side, an accurate tentative decision is possible, but the replica signal contains errors due to channel estimation. Therefore, under the assumption that the channel estimation is comparatively accurate (expected error values are small), it is appropriate to make the weighting coefficient λ_{A}^{Q} equal to 1 or close to 1. In fact, λ_{A}^{Q} can also be set to a fixed value close to 1.

Since the uncoded bit error rate (BER) of the other control bits and data bits depends on the signal-to-interference ratio SIR, it is appropriate to set their weighting coefficients λ_{B}^{Q} and λ^{I} to depend on the SIR. The determination of the weighting coefficients may be due to either the average SIR (with respect to high-speed fading) or the instantaneous SIR. The rules for determination of these weighting coefficients allows for the performance of flexible interference cancellation responsive to the situation as compared with methods of setting the same weighting coefficient for all DPCH's.

Next, a coefficient determining method based on the second aspect of the present invention shall be described. The coefficient determining method according to the second aspect of the present invention is one wherein the weighting coefficients are set so as to minimize the power of the interference cancellation residual signal after the interference cancellation process for each user and each stage.

Herebelow, a W-CDMA uplink shall be taken as an example for describing the operating principles of the weighting coefficient determining method based on the second aspect of the present invention. The communication data structure and modulation explained below is based on the 3GPP standard (see 3GPP, “Physical Channels and Mapping of Transport Channel onto Physical Channels (DD)”, TS 25.211 v2.1.0, 1999-6).

First, the received signal r(t) can, in general, be expressed as follows:

$$r ( t ) = {\sum }_{i = 1}^{N} {\sum }_{k = 1}^{K} {\sum }_{l = 1}^{L} {h}_{k , l} ( t ) {c}_{k} ( t - {τ}_{k , l} ) {b}_{k , l , i} ( t ) + n ( t ) \\ {b}_{k , l , i} ( t ) = \{ \begin{matrix}{a}_{k , i} & {iT}_{b} \leq t - {τ}_{k , l} < ( i + 1 ) {T}_{b} \\ 0 & others\end{matrix} \qquad [ Eq . 21 ]$$

Here, N denotes the number of symbols, K denotes the number of users, L denotes the total number of paths, h_{k,l}(t) denotes the first channel coefficient of the k-th user, cₖ(t) denotes the spreading code, b_{k,l,i}(t) denotes a rectangular pulse indicating the symbol duration relating to the i-th symbol a_{k,i} of the k-th user, T_{b} denotes the duration of one symbol, τ_{k,1} denotes the first channel delay of the k-th user and n(t) is Gaussian white noise which is to be added. In the present specification, the parallel IC (PIC) or serial IC (SIC) is assumed to be provided at the base station (BS).

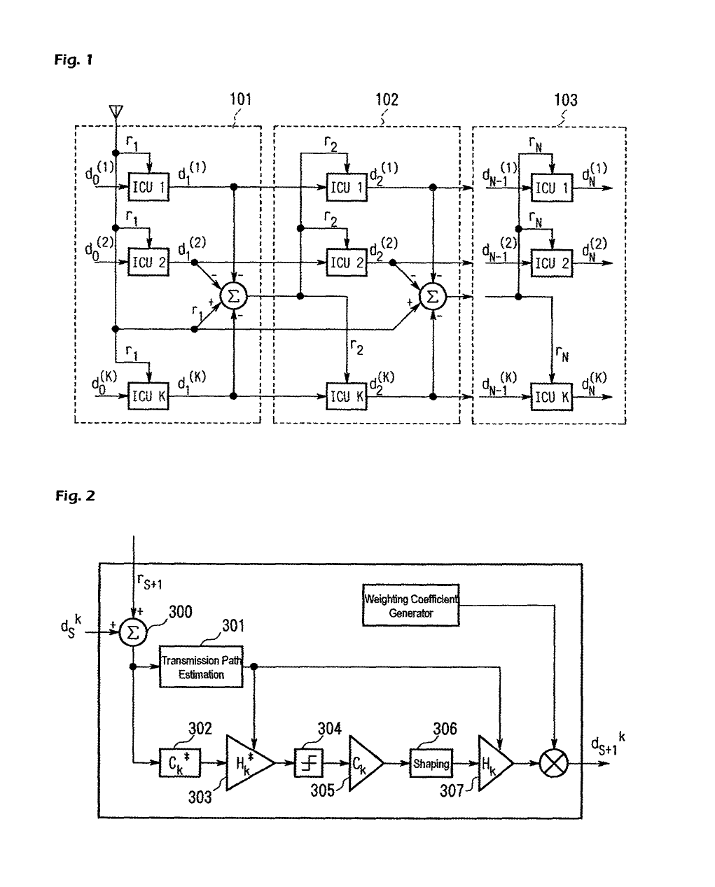

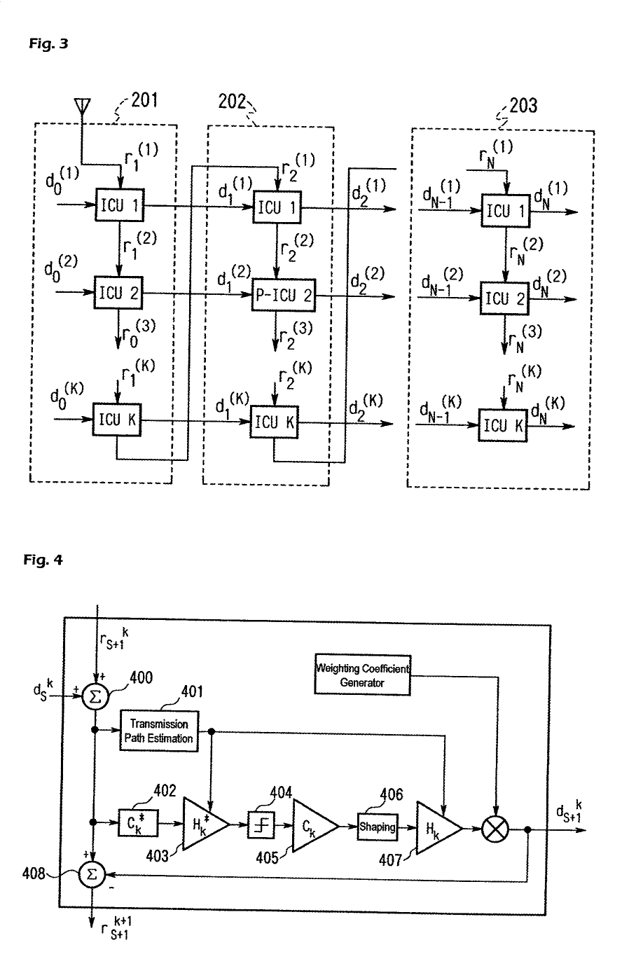

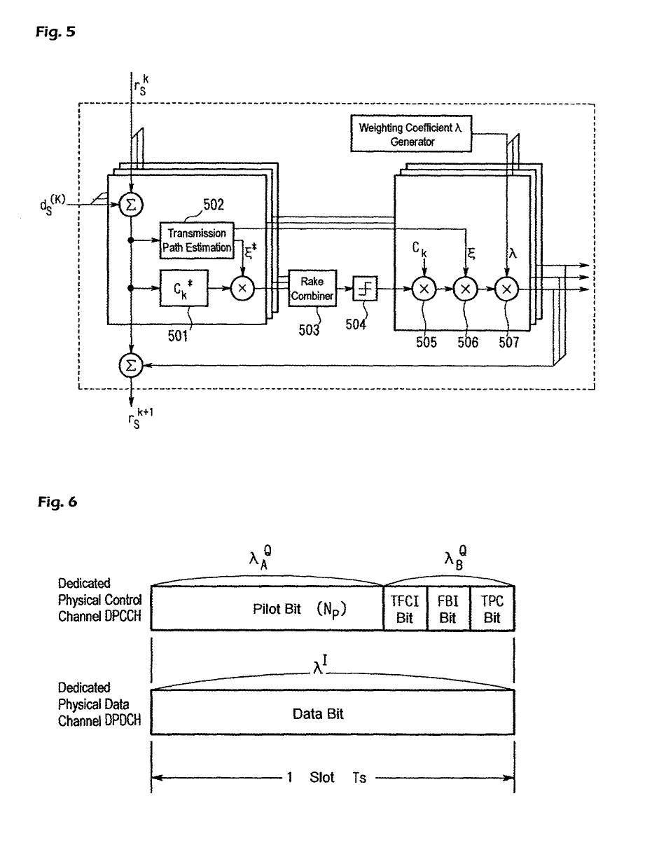

The basic structures of the multi-stage PIC and SIC are the same as those already described with reference to FIGS. 1 and 3 in connection with the conventional art. Additionally, the basic structure of the interference canceller unit is roughly the same as those shown in FIGS. 2 and 4 with the exception of the weighting coefficient determining method.

According to the above expression, the residual signal rₖ^{S} of the PIC and SIC can respectively be expressed as follows.

PIC residual signal:

$${r}_{{k}^{′}}^{s} ( t ) = {\sum }_{i = 1}^{N} {\sum }_{k = 1}^{K} {\sum }_{l = 1}^{L} {b}_{k , l , i} ( t ) {c}_{k} ( t - {τ}_{k , l} ) {h}_{k , l} ( t ) - {B}_{k , l , i}^{s} ( t ) {c}_{k} ( t - {τ}_{k , l} ) {H}_{k , l}^{s} ( t ) + n ( t ) \qquad [ Eq . 22 ]$$

SIC residual signal.

$${r}_{{k}^{′}}^{s} ( t ) = {\sum }_{i = 1}^{N} {\sum }_{k = 1}^{K} {\sum }_{l = 1}^{L} {b}_{k , l , i} ( t ) {c}_{k} ( t - {τ}_{k , l} ) {h}_{k , l} ( t ) + n ( t ) - {\sum }_{i = 1}^{N} {\sum }_{k = 1}^{{k}^{′} - 1} {\sum }_{l = 1}^{L} {B}_{k , l , i}^{s} ( t ) {c}_{k} ( t - {τ}_{k , l} ) {H}_{k , l}^{s} ( t ) - {\sum }_{i = 1}^{N} {\sum }_{k = {k}^{′}}^{K} {\sum }_{l = 1}^{L} {B}_{k , l , i}^{s - 1} ( t ) {c}_{k} ( t - {τ}_{k , l} ) {H}_{k , l}^{s - 1} ( t ) \qquad [ Eq . 23 ]$$

In the above equations, B_{k,l}^{S} denotes the tentative decision symbol of the s-th stage of the l-th path of the k-th user.

(Expected Value of Residual Signal)

Assuming that the noise is independent of the signal and channel and the signal of each user is independent of the signals of other users, the average values of these are all zero. Therefore, the expect power value of the residual signal received in the PIC can be expressed b the following equation.

$$E [ {\vert {r}_{{k}^{′}}^{s} ( t ) \vert}^{2} ] = {\sum }_{i = 1}^{N} {\sum }_{k = 1}^{K} {\sum }_{l = 1}^{L} E [ {\vert {h}_{k , l} ( t ) {b}_{k , l , i} ( t ) - {H}_{k , l}^{s} ( t ) {B}_{k , l , i}^{s} ( t ) \vert}^{2} ] + \frac{{N}_{0}}{2} \qquad [ Eq . 24 ]$$

Additionally, in the case of an SIC, the expected power value of the residual signal is as follows.

$$E [ {\vert {r}_{{k}^{′}}^{s} ( t ) \vert}^{2} ] = {\sum }_{i = 1}^{N} {\sum }_{k = 1}^{{k}^{′} - 1} {\sum }_{l = 1}^{L} E [ {\vert {h}_{k , l} ( t ) {b}_{k , l , i} ( t ) - {H}_{k , l}^{s} ( t ) {B}_{k , l , i}^{s} ( t ) \vert}^{2} ] + {\sum }_{i = 1}^{N} {\sum }_{k = {k}^{′}}^{K} {\sum }_{l = 1}^{L} E [ {\vert {h}_{k , l} ( t ) {b}_{k , l , i} ( t ) - {H}_{k , l}^{s - 1} ( t ) {B}_{k , l , i}^{s - 1} ( t ) \vert}^{2} ] + \frac{{N}_{0}}{2} \qquad [ Eq . 25 ]$$

(Determination of Least Square Error Weighting Coefficients)

According to Equations 24 and 25, minimizing the expected power value of the received residual signal on the lefthand side of the equation is equivalent to minimizing the values indicated in the form of a sum on the righthand side of the equation.

Therefore, by introducing the weighting coefficient λ_{k,l}^{S} and expressing the power of the received residual signal in the case of using the weighting coefficient by means of the evaluation function C, the evaluation function C can be expressed as follows.

$$C ( {h}_{k , l} , {\hat{h}}_{k , l}^{s} , {b}_{k} , {\hat{b}}_{k}^{s} ) = {\vert {h}_{k , l} {b}_{k} - {λ}_{k , l}^{s} {H}_{k , l}^{s} {B}_{k}^{s} \vert}^{2} \qquad [ Eq . 26 ]$$

Hereafter, the time t shall be omitted for the purpose of simplification in the expression of functions of time, so that x(t) will be expressed simply as x. The expected value of the evaluation function indicated above is shown below.

$$\begin{matrix}{I}_{k , l}^{s} = E [ C ( {h}_{k , l} , {H}_{k , l}^{s} , {b}_{k} , {B}_{k}^{s} ) ] \\ = \int ⅆ {h}_{k , l} \int ⅆ {H}_{k , l}^{s} \int ⅆ {b}_{k} \int ⅆ {B}_{k}^{s} \vert {h}_{k , l} {b}_{k} - \\ { {λ}_{k , l}^{s} {H}_{k , l}^{s} {B}_{k}^{s} \vert}^{2} f ( {h}_{k , l} , {H}_{k , l}^{s} , {b}_{k} , {B}_{k}^{s} )\end{matrix} \qquad [ Eq . 27 ]$$

Here, f(h_{k,l}, H_{k,l}^{S}, bₖ, Bₖ^{S}) is a combined probability density function relating to channel h_{k,l}, estimated channel H_{k,l}^{S}, received signal bₖ and tentative decision symbol Bₖ^{S}.

Upon taking the derivative of the expected value I_{k,l}^{S} of the evaluation function with respect to the complex conjugate of the weighting coefficient, the condition under which the expected value I_{k,l}^{S} of the evaluation function is minimized with respect to the weighting coefficient λ_{k,l}^{S} can be expressed as follows:

$$\frac{\partial {I}_{k , l}^{s}}{\partial {λ}_{k , l}^{s *}} = 0 \qquad [ Eq . 28 ]$$

Therefore, the weighting coefficient which minimizes the expected value I_{k,l}^{S} of the evaluation function can be expressed as follows.

$${λ}_{k , l}^{s} = \frac{\int ⅆ {h}_{k , l} \int ⅆ {H}_{k , l}^{s} \int ⅆ {b}_{k} \int ⅆ {B}_{k}^{s} {H}_{k , l}^{s} * {b}_{k} {B}_{k}^{s} * f ( {h}_{k , l} , {H}_{k , l}^{s} , {b}_{k} , {B}_{k}^{s} )}{\int ⅆ {h}_{k , l} \int ⅆ {H}_{k , l}^{s} \int ⅆ {b}_{k} \int ⅆ {B}_{k}^{s} {\vert {H}_{k , l}^{s} {B}_{k}^{s} \vert}^{2} f ( {h}_{k , l} , {H}_{k , l}^{s} , {b}_{k} , {B}_{k}^{s} )} \qquad [ Eq . 29 ]$$

In particular, given the estimated channel H_{k,l}^{S} and the tentative decision bₖ^{S}, Equation 29 can be modified to the following equation.

$${λ}_{k , l}^{s} = ( {H}_{k , l}^{s} , {B}_{k}^{s} ) = \frac{\int ⅆ {h}_{k , l} \int ⅆ {b}_{k} {h}_{k , l} {b}_{k} f ( {h}_{k , l} , {H}_{k , l}^{s} , {b}_{k} , {B}_{k}^{s} )}{{H}_{k , l}^{s} {B}_{k}^{s}} \qquad [ Eq . 30 ]$$

(Approximation of Least Square Error Weighting Coefficient)

Since the above-mentioned weighting coefficient requires taking the integral of the channel or estimated channel, the actual computation is difficult. In order to simplify the calculations for computing the optimum weighting coefficients, it is preferable to be able to determine them without any integration operations.

If the number of fingers of the rake receiver is large enough to assume that the probability of errors occurring in the tentative decision as the result of a single path channel will be small the probability density function of the tentative decision error can be considered as being independent of the channel coefficient h_{k,l} and estimated channel H_{k,l}^{S}. Under this assumption, the weighting coefficient described in Equation 29 can be expressed as follows.

$${λ}_{k , l}^{2} ( {H}_{k , l}^{s} , {B}_{k}^{s} ) ≅ \frac{\int ⅆ {b}_{k} {b}_{k} f ( {h}_{k , l} , {H}_{k , l}^{s} , {b}_{k} , {B}_{k}^{s} )}{{B}_{k}^{s}} \qquad [ Eq . 31 ]$$

Then, by expressing the communication signal using the tentative decision as follows:

$${b}_{k} ≡ {A}_{k}^{s} {ⅇ}^{{ⅈϕ}_{k}^{s}} {B}_{k}^{s} \qquad [ Eq . 32 ]$$

Particularly for the case of QPSK, the relative amplitude Aₖ^{S} and phase error φₖ^{S} can be expressed respedtively as follows:

$$\begin{matrix}{A}_{k}^{s} = 1 \\ {ϕ}_{k}^{s} = \frac{π}{2} n ( n = 0 , 1 , 2 , 3 )\end{matrix} \qquad [ Eq . 33 ]$$

Using the above expression, the righthand side of Equation 31 which expresses the weighting coefficient becomes as follows:

$$\begin{matrix}\frac{\int ⅆ {b}_{k} {b}_{k} f ( {h}_{k , l} , {H}_{k , l}^{s} , {b}_{k} , {B}_{k}^{s} )}{{B}_{k}^{s}} = \int ⅆ {b}_{k} {A}_{k}^{s} {ⅇ}^{{ⅈϕ}_{k}^{s}} f ( {h}_{k , l} , {H}_{k , l}^{s} , {b}_{k} , {B}_{k}^{s} ) \\ = f ( {h}_{k , l} , {H}_{k , l}^{s} , {B}_{k}^{s} , {B}_{k}^{s} ) + \\ f ( {h}_{k , l} , {H}_{k , l}^{s} , {ⅇ}^{{ⅈϕ}_{I}} {B}_{k}^{s} , {B}_{k}^{s} ) {ⅇ}^{{ⅈϕ}_{I}} + \\ f ( {h}_{k , l} {H}_{k , l}^{s} , {ⅇ}^{{ⅈϕ}_{Q}} {B}_{k}^{s} , {B}_{k}^{s} ) {ⅇ}^{{ⅈϕ}_{Q}} - \\ f ( {h}_{k , l} , {H}_{k , l}^{s} , {ⅇ}^{ⅈπ} {B}_{k}^{s} , {B}_{k}^{s} )\end{matrix} \qquad [ Eq . 34 ]$$

Here, φ_{I} and φ_{Q} denote phase error differences in the case where only the I or Q phase contains measurement errors, expressed as follows.

$${ϕ}_{I} = sgn ( real ( {B}_{k}^{s} ) ) sgn ( imag ( {B}_{k}^{s} ) ) 2 ( \frac{π}{2} - a tan \vert \frac{imag ( {B}_{k}^{s} )}{real ( {B}_{k}^{s} )} \vert ) \\ {ϕ}_{Q} = - sgn ( real ( {B}_{k}^{s} ) ) sgn ( imag ( {B}_{k}^{s} ) ) 2 a tan \vert \frac{imag ( {B}_{k}^{s} )}{real ( {B}_{k}^{s} )} \vert \qquad [ Eq . 35 ]$$

(Method for Calculating Probability Density Function ƒ

The method for calculating the probability density function used in Equation 34 shall be described below.

The probability density function of the tentative decision error can be determined using the SIRS Assuming that the channel estimation has been performed ideally, in the case of QPSK, the I or Q branch of the tentative decision error probability can be expressed as follows:

$$g ( {SIR}_{I ( Q )} \vert {h}_{k , l} , {H}_{k , l}^{s} , {b}_{k} , {B}_{k}^{s} ) = \frac{1}{\sqrt{2 π}} {{{\int }^{∞} ⅇ}_{\sqrt{{SIR}_{I ( Q )}}}}^{- \frac{{x}^{2}}{2}} ⅆ x \qquad [ Eq . 36 ]$$

Here, SIR_{I(Q)} is the signal-to-interference ratio of the I(Q) branch. Therefore, the error probability function becomes as follows.

$$f ( {h}_{k , l} , {H}_{k , l}^{s} , {B}_{k}^{s} , {B}_{k}^{s} ) = ( 1 - g ( {SIR}_{I} \vert {h}_{k , l} , {H}_{k , l}^{s} , {b}_{k} , {B}_{k}^{s} ) ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{I}} , {B}_{k}^{s} ) = g ( {SIR}_{I} \vert {h}_{k , l} , {H}_{k , l}^{s} , {b}_{k} , {B}_{k}^{s} ) ( 1 - g ( {SIR}_{Q} \vert {h}_{k , l} , {H}_{k , l}^{, s} , {b}_{k} , {B}_{k}^{s} ) ) \\ f ( {h}_{k , l} , {H}_{k , l}^{s} , {B}_{k}^{s} {ⅇ}^{{ⅈϕ}_{Q}} , {B}_{k}^{s} ) = ( 1 - g ( {SIR}_{I} \vert {h}_{k , l} , {H}_{k , l}^{s} , {b}_{k} , {B}_{k}^{s} ) ) g ( {SIR}_{Q} \vert {h}_{k , l} , {H}_{k , l}^{s} , {b}_{k} , {B}_{k}^{s} ) \\ f ( {h}_{k , l} , {H}_{k , l}^{s} , - {B}_{k}^{s} , {B}_{k}^{s} ) = g ( {SIR}_{I} \vert {h}_{k , l} , {H}_{k , l}^{s} , {b}_{k} , {B}_{k}^{s} ) g ( {SIR}_{Q} \vert {h}_{k , l} , {H}_{k , l}^{s} , {b}_{k} , {B}_{k}^{s} ) \\ \qquad [ Eq . 37 ]$$

Using the equations 34-37, in the case of QPSK, it is possible to determine the weighting coefficient λ_{k,l}^{S} based on the tentative decision symbol Bₖ^{S} and the signal-to-interference ratios SIR_{I} and SIR_{Q} of the I and Q branches. Therefore, by using this principle to determine the weighting coefficient based on the tentative decision symbol of each user and the signal-to-interference ratio of the I and Q branches in each stage, the optimum weighting process can be performed.

In an actual system, the error included in the channel estimation and measured SIR can cause the interference to increase upon performing interference cancellation. Accordingly, in order to suppress reductions in quality due to errors, it is desirable to reduce the measured SIR and use this reduced SIR when calculating the probability density function of the tentative decision error in the I(Q) branch.

Here, taking the power ratio between the I and Q branches as γ, φ_{I} and φ_{Q} in Equation 35 can be expressed by the following equations.

φ_{I}=π−2a tan (β) [Eq. 38]

φ_{Q}=2a tan (β) [Eq. 39]

In the equations, β denotes a value calculated on the basis of the power ratio γ expressed as follows.

$$β = \frac{1}{\sqrt{γ}} \qquad [ Eq . 40 ]$$

Expressing the first through fourth equations in Equation 37 as ƒ₀, ƒ_{φI}, ƒ_{φQ} and ƒ_{π}, Equation 34 can be expressed as follows.

λ=ƒ₀+ƒ_{φ}_{_{I}}e^{iφ}^{_{I}}+ƒ_{φ}_{_{Q}}e^{iφ}^{_{Q}}+ƒ_{π}e^{iπ} [Eq. 41]

According to this Equation 41, the real and imaginary parts of the weighting coefficient λ can be expressed as follows.

λᵣₑₐₗ=real(λ)=ƒ₀−ƒ_{π}+ƒ_{φ}_{_{I}} cos (φ_{I})+ƒ_{φ}_{_{Q}} cos (φ_{Q}) [Eq. 42]

λ_{imag}=imag(λ)=−ƒ_{φ}_{_{I}} sin (φ^{I})−ƒ_{φ}_{_{Q}} sin (φ_{Q}) [Eq. 43]

Using these Equations 42 and 43, the weighting coefficients of the I and Q branches can be expressed respectively as follows.

λ_{I}=(λᵣₑₐₗ−βλ_{imag}) [Eq. 44]

$${λ}_{Q} = ( {λ}_{real} + \frac{{λ}_{imag}}{β} ) \qquad [ Eq . 45 ]$$

Using the Equations 34-45, it is possible to determine the respective weighting coefficients λ^{I} and λ^{Q} of the I and Q branches using the power ratio γ of the I and Q branches instead of the tentative decision symbols.

### EXAMPLES

Herebelow, an interference canceller unit and interference canceller for specifically achieving the above-described theoretical operations shall be described.

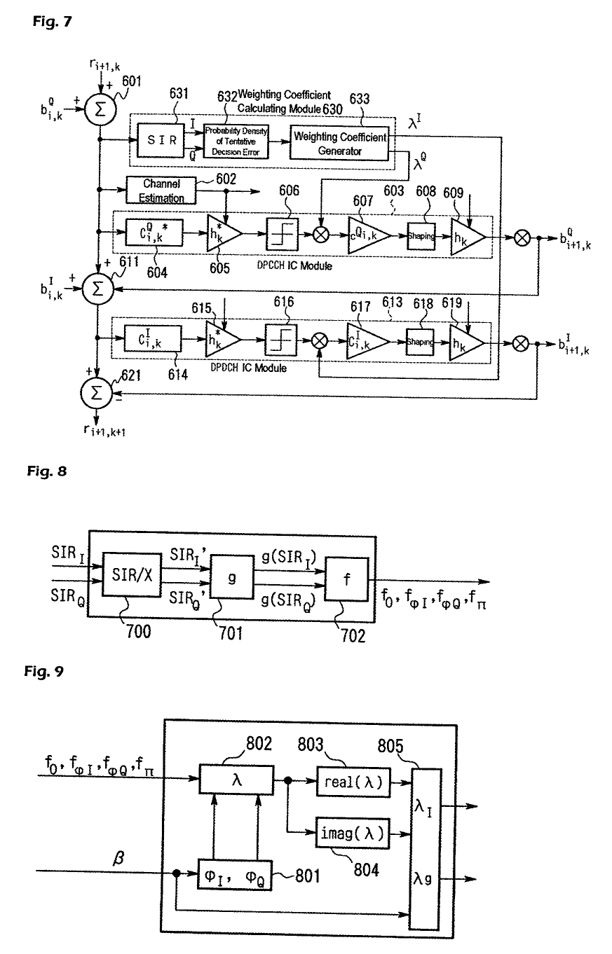

FIG. 7 shows the structure of an interference canceller unit comprising a weighting coefficient calculation module for calculating weighting coefficients based on the power ratio of the I and Q branches as mentioned above.

The interference canceller unit shown in FIG. 7 corresponds to an interference canceller unit of the SIC shown in FIG. 4, specifically the interference canceller unit for user k in the (i+1)-th stage. The unit comprises a DPCCH module 603 for determining a replica signal of the dedicated physical control channel (DPCCH), a DPDCH module 613 for determining a replica signal of the dedicated physical data channel (DPDCH) and a weighting coefficient calculating module 630 for determining weighting coefficients λ_{Q} and λ_{I} corresponding respectively to the DPCCH and DPDCH.

The interference canceller unit receives as inputs an interference cancellation residual signal r_{i+1,k}, and i-th stage replica signals b_{i,k}^{Q} and b_{i,k}^{I} corresponding to the Q and I channels. First, a first adder 601 which has received the interference cancellation residual signal r_{i+1,k}, and the Q channel replica signal b_{i,k}^{Q} adds the two signals together, and outputs the result to the weighting coefficient calculating module 630, the channel estimating portion 602 and DPCCH module 603.

In the DPCCH interference cancellation module 603, the input signal is despread using the spreading code c_{i,k}^{Q}* of that user (604), and transmission path correction is performed with the channel estimation vector hₖ from the channel estimating portion 602. The signal which has been transmission path corrected is combined with signals of other paths by means of a rake combiner not shown, and inputted to the decision making device 606. The decision making device 606 performs symbol decisions based on the input signal, and outputs the determined symbols. The decision symbols are subsequently multiplied by the weighting coefficient λ_{Q} supplied from the weighting coefficient calculating module 630 to perform a weighting procedure. After the weighting process, the symbols are respread by means of the spreading code c_{i,k}^{Q}* of that user (607), shaped (608), then transmission path decorrected using the channel estimation hk from the channel estimating portion 602 and outputted as the replica signal b_{i+1,k}^{Q}.

On the other hand, in the weighting coefficient calculating module 630, the SIR of the I channel and Q channel are determined by the SIR measuring portion 631. In this case, in the SIR measuring portion 631, the SIR of the Q channel is determined, for example, based on the pilot signal of the Q channel, and with regard to the SIR of the I channel, the SIR of the I channel is determined by multiplying a factor based on the I/Q power ratio to the SIR of the Q channel. Next, in the probability density calculating portion 632, the probability density of the tentative decision error is determined on the basis of the SIR of the I and Q channels calculated in the previous stage. At the weighting coefficient generator 633 which follows, the weighting coefficients λ^{I} and λ^{Q} of the I and Q channels are calculated on the basis of the probability density of the tentative decision error calculated in the previous stage and the I/Q power ratio.

The replica signal b_{i+1,k}^{Q} of the Q channel outputted from the DPCCH module 603 is inputted along with the output of the adder 601 and the replica signal b_{i,k}^{I} of the I channel from the i-th stage to the second adder 611. The second adder 611 subtracts the replica signal b_{i+1,k}^{Q} of the Q channel from the sum signal from the adder 601 to eliminate the influence of the DPCCH, and adds the replica signal b_{i,k}^{I} of the I channel, then outputs the result to the DPCCH module 613.

In the DPCCH module 613, the input signal is despread using the spreading code c_{i,k}^{I}* of that user (614), and transmission path correction is performed with the channel estimation vector hₖ from the channel estimating portion 602. The signal which has been transmission path corrected is combined with signals of other paths by means of a rake combiner not shown, and inputted to the decision making device 616. The decision making device 616 performs symbol decisions based on the input signal, and outputs the determined symbols. The decision symbols are subsequently multiplied by the weighting coefficient λ_{I} supplied from the weighting coefficient calculating module 630 to perform a weighting procedure. After the weighting process, the symbols are respread by means of the spreading code c_{i,k}^{I}* of that user (617), shaped (618), then transmission path decorrected using the channel estimation hₖ from the channel estimating portion 602 and outputted as the replica signal b_{i+1,k}^{I}. This replica signal b_{i+1,k}^{I} is inputted to the third adder 621. At the third adder 621, the replica signal b_{i+1,k}^{I} is subtracted from the sum signal outputted from the second adder, and the result is outputted as a residual signal r_{i+1,k+1} with the influence of user k removed.

In an interference canceller unit structured in this way and a serial interference canceller having such units as the constituent elements, the weighting coefficients are set by the above-mentioned weighting coefficient determining method, so as to be able to perform efficient interference cancellation. Whereas in FIG. 7, an example of application of a weighting coefficient calculating module to an interference canceller unit for a serial interference canceller was described, the weighting coefficient calculating module may also naturally be applied to an interference canceller unit in a parallel interference canceller, the same effects being able to be obtained in the case of application to the parallel type.

Next, the specific structure of the above-mentioned weighting coefficient calculating module 630 shall be described.

FIG. 8 shows the structure of a probability density calculating portion 632 used in the above-described weighting coefficient calculating module 630. First, the SIR_{I} and SIR_{Q} of the I channel and Q channel from the SIR measuring portion 631 are respectively inputted to the SIR reducing portion 700. The SIR reducing portion 700 is for reducing the errors in the measured signal-to-interference ratio, and reduces the inputted SIR_{I} and SIR_{Q} to 1/X (X is a predetermined value, this reducing procedure for example reducing the SIR_{I} and SRI_{Q} by about 1-3 dB). The reduced signal-to-interference ratios SIR_{I}′ and SIR_{Q}′ are inputted to the error probability calculating portion 701 which follows. The error probability calculating portion 701 is for determining the error probability of the tentative decision, and uses the above-given Equation 36 to determine the error probabilities g (SIR_{I}) and g (SIR_{Q}) based on the inputted SIR_{I}′ and SIR_{Q}′. The probability density calculating portion 702 is for determining the probability density function of the tentative decision error, and uses the above-given Equation 37 to determine the probability density functions ƒ₀, ƒ_{φI}, ƒ_{φQ} and ƒ_{π} based on the inputted error probabilities g (SIR_{I}) and g (SIR_{Q}). ƒ₀, ƒ_{φI}, ƒ_{φQ} and ƒ_{π} respectively correspond to the first through fourth equations in Equation 37.

While it is mentioned here that the values are calculated using numerical formulas, it is also possible to prepare a correspondence table of numerical values and to look them up in order to determine the values.

Next, FIG. 9 shows the structure of the weighting coefficient generator 633 of the above-described weighting coefficient calculating module 630.

As shown in FIG. 9, the weighting coefficient generator 633 receives as inputs the probability density functions ƒ₀, ƒ_{φI}, ƒ_{φQ} and ƒ_{π} from the probability density calculating portion 632 of the previous stage, and the value β calculated using the above-described Equation 40 based on the I/Q power ratio γ.

The calculating portion 801 uses the above-given Equations 38 and 39 to determine the phase errors φ_{I} and φ_{Q} from the value β, and the calculating portion 802 uses the above-given Equation 41 to calculate the weighting coefficient λ based on the phase errors φ_{I} and φ_{Q} and the probability density functions ƒ₀, ƒ_{φI}, ƒ_{φQ} and ƒ_{π}. The calculating portions 803 and 804 respectively use the above-given Equations 42 and 43 to determine the real part λᵣₑₐₗ and imaginary part λ_{imag} of the weighting coefficient λ, and the calculating portion 805 uses the above-given Equations 44 and 45 to calculate the weighting coefficients λ_{I} and λ_{Q} of the I and Q channels based on λᵣₑₐₗ, λ_{imag} and β. The weighting coefficients β_{I} and β_{Q} calculated in this way are respectively outputted to the DPCCH module 603 and DPDCH module 613 as mentioned above, multiplied by the tentative decision symbol of the I channel and the tentative decision symbol of the Q channel, and used for the weighting process.

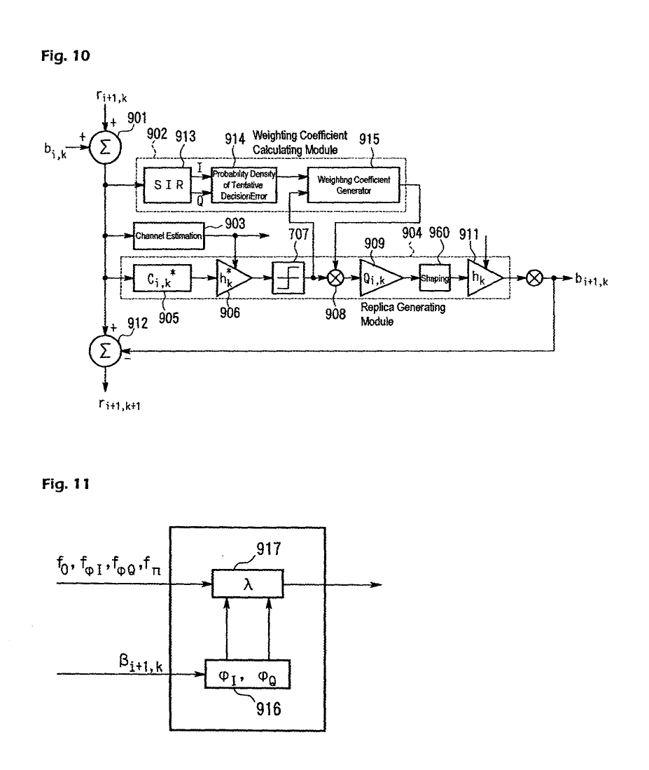

Next, FIG. 10 shows the structure of an interference canceller unit comprising a weighting coefficient calculating module for calculating weighting coefficients based on the tentative decision symbol as explained by the above-described principle.

The interference canceller unit shown in FIG. 10, while adapted to be an SIC interference canceller unit, performs interference cancellation without separating the signals into a DPCCH and DPDCH, and shows an interference canceller unit for user k in the (i+1)-th stage.

This interference canceller unit receives as inputs the interference cancellation residual signal r_{i+1,k} and the i-th stage interference replica signal b_{i,k}. The first adder 901 adds together the interference cancellation residual signal r_{i+1,k} and the i-th stage interference replica signal b_{i,k}, and outputs the result to to the weighting coefficient calculating module 902, the channel estimating portion 903 and the replica generating module 904. The channel estimating portion 903 is the same as that shown in FIG. 7, and determines and outputs the channel estimating vector hₖ. At the replica generating module 904, the input signals are despread by the spreading code c_{i,k}* of the user (905), and transmission path correction is performed with the channel estimating vector hₖ from the channel estimating portion 903. The transmission path corrected signal is combined with the signals of other paths by a rake combiner not shown, then inputted to the decision making device 907. The decision making device 907 performs a symbol decision based on the input signal, then outputs the tentative decision symbol to the weighting coefficient module 902 and the multiplying portion 908 of a latter stages.

The multiplying portion 908 multiplies a weighting coefficient A received from the weighting coefficient calculating module 902 to perform weighting of the tentative decision symbol. The weighted symbol is respread with the spreading code c_{i,k}* of that user (909), shaped (910), then transmission path decorrected using the channel estimation hₖ from the channel estimating portion 903 and outputted as a replica signal b_{i+1,k}. This replica signal b_{i+1,k} is inputted to the second adder 912, and subtracted from a signal from the first adder 901. Consequently, a residual signal r_{i+1,k+1} with the influence of the user k removed is generated.

On the other hand, at the weighting coefficient calculating module 902, the SIR of the I channel and the Q channel are respectively determined by the SIR measuring portion 913. The SIR measuring portion 913 is the same as the SIR measuring portion 602 shown in FIG. 7, and determines the SIR of each channel using the same method. The probability density calculating portion 914 which follows is also basically the same as the probability density calculating portion 632 shown in FIG. 7, and determines the probability density functions ƒ₀, ƒ_{φI}, ƒ_{φQ} and ƒ_{π} using the above-given Equations 36 and 37.

The weighting coefficient generator 915 which follows has the structure shown in FIG. 11. The calculating portion 916 uses the above-given Equation 35 to determine the phase errors φ_{I} and φ_{Q} based on the tentative decision symbol B_{i+1,k}, and the calculating portion 917 uses the above-given Equation 34 to calculate the weighting coefficient λ based on the probability density functions ƒ₀, ƒ_{φI}, ƒ_{φQ} and ƒ_{π} of the tentative decision error and the phase errors φ_{I} and φ_{Q}. The thus determined weighting coefficient λ which is composed of a complex number is outputted to the replica generating module 904 as mentioned above, and used for the weighting procedure. Here, the values are described as being calculated using formulas, but it is also possible to prepare a correspondence table for the numerical values, and the find the values by looking them up.

In an interference canceller unit having the above-described structure and a serial interference canceller with such units as the constituent elements, the weighting coefficients are determined by the above-described weighting coefficient determining method, thus enabling efficient interference cancellation. Whereas in FIG. 10, an example of application of a weighting coefficient calculating module to an interference cancellation unit for a serial interference canceller was given, this weighting coefficient calculating module can of course be applied just as well to an interference canceller unit for a parallel interference canceller, and similar effects can be obtained even in the case of application to the parallel type.

Thus, in the present invention, a weighting process is performed by determining the optimum weighting coefficient based on the signal-to-interference ratio and tentative decision symbol or I/Q power ratio for each user and each stage, thereby enabling the precision of interference cancellation to be further improved.

As explained in the first aspect of the present invention, it is desirable to apply the above-mentioned method for calculating weighting coefficients using tentative decision symbols when setting weighting coefficients independently for different bit groups.

### Industrial Applicability

According to the invention as described above, the interference cancellation precision can be further improved by performing weighting procedures by determining the optimum weighting coefficients for each user and each stage.

What is claimed is:

1. A weighting coefficient determining method in a subtractive interference canceller for digital radio communications wherein the communication channel is composed of pilot bits, other control bits and data bits;
the weighting coefficient determining method being characterized in that the weighting coefficient λ_{A}^{Q} of the pilots bits, the weighting coefficient λ_{B}^{Q} of the other control bits and the weighting coefficient λ^{I} of the data bits are mutually independent values.

2. A weighting coefficient determining method according to claim 1, wherein said weighting coefficients λ_{A}^{Q}, λ_{B}^{Q} and λ^{I} are determined for each user and stage based on a tentative decision symbol and an average or instantaneous signal-to-interference ratio SIR.

3. A weighting coefficient determining method according to claim 2, wherein signal-to-interference ratios SIR_{I} and SRI_{Q} respectively of an I branch and a Q branch are used as the signal-to-interference ratio SIR, and the weighting coefficients λ^{I} and λ^{Q} of the I branch and Q branch are derived from tentative decision symbol and a tentative decision error probability density function derived from the signal-to-interference ratios SIR_{I} and SIR_{Q}.

4. A weighting coefficient determining method in a subtractive interference canceller adapted for digital radio communications, wherein the weighting coefficients are set so as to minimize the power of the interference cancellation residual signal for each channel in each stage.

5. A weighting coefficient determining method according to claim 4, wherein said weighting coefficients are derived based on the relationship expressed by the following equation:
$${λ}_{k , l}^{s} ( {H}_{k , l}^{s} , {B}_{k}^{s} ) = \frac{\int ⅆ {h}_{k , l} \int ⅆ {b}_{k} {h}_{k , l} {b}_{k} f ( {h}_{k , l} , {H}_{k , l}^{s} , {b}_{k} , {B}_{k}^{s} )}{{H}_{k , l}^{s} {B}_{k}^{s}} \qquad [ Eq . 46 ]$$
Wherein λ_{k,l}^{S} denotes the weighting coefficient of the l-th path for the k-th user in the s-th stage;
H_{k,l}^{S} denotes the estimated channel of the l-th path for the k-th user in the s-th stage;
Bₖ^{S} denotes the tentative decision symbol of the k-th user in the s-th stage;
h_{k,l}(t) denotes the channel coefficient of the l-th path for the k-th user;
bₖ denotes the signal received by the k-th user; and
f(h_{k,l}, H_{k,l}^{S}, bₖ, Bₖ^{S}) is a combined tentative decision error probability density function relating to the channel coefficient h_{k,l}, the estimated channel H_{k,l}, the received signal bₖ and the tentative decision symbol Bₖ^{S}.

6. A weighting coefficient determining method according to claim 5, wherein said weighting coefficients are approximated as follows:
$${λ}_{k , l}^{s} ( {H}_{k , l}^{s} , {B}_{k}^{s} ) ≅ \frac{\int ⅆ {b}_{k} {b}_{k} f ( {h}_{k , l} , {H}_{k , l}^{s} , {b}_{k} , {B}_{k}^{s} )}{{B}_{k}^{s}} . \qquad [ Eq . 47 ]$$

7. A weighting coefficient determining method according to claim 6, wherein said weighting coefficients are further determined by taking the received signal bₖ as follows:
$${b}_{k} = {A}_{k}^{s} {ⅇ}^{{ⅈϕ}_{k}^{s}} \qquad \{ Eq . 48 ]$$
And using the following relationship:
$$\begin{matrix}\frac{\int ⅆ {b}_{k} {b}_{k} f ( {h}_{k , l} , {H}_{k , l}^{s} , {b}_{k} , {B}_{k}^{s} )}{{B}_{k}^{s}} = \int ⅆ {b}_{k} {A}_{k}^{s} {ⅇ}^{{ⅈϕ}_{k}^{s}} f ( {h}_{k , l} , {H}_{k , l}^{s} , {b}_{k} , {B}_{k}^{s} ) \\ = f ( {h}_{k , l} , {H}_{k , l}^{s} , {B}_{k}^{s} , {B}_{k}^{s} ) + \\ f ( {h}_{k , l} , {H}_{k , l}^{s} , {ⅇ}^{{ⅈϕ}_{I}} {B}_{k}^{s} , {B}_{k}^{s} ) {ⅇ}^{{ⅈϕ}_{I}} + \\ f ( {h}_{k , l} , {H}_{k , l}^{s} , {ⅇ}^{{ⅈϕ}_{Q}} {B}_{k}^{s} , {B}_{k}^{s} ) {ⅇ}^{{ⅈϕ}_{Q}} - \\ f ( {h}_{k , l} , {H}_{k , l}^{s} , {ⅇ}^{ⅈπ} {B}_{k}^{s} , {B}_{k}^{s} )\end{matrix} \qquad [ Eq . 49 ]$$
Wherein φ_{I} and φ_{Q} are phase errors when only the I or Q phase contains measurement errors, and are expressed as follows:
$${ϕ}_{I} = sgn ( real ( {B}_{k}^{s} ) ) sgn ( imag ( {B}_{k}^{s} ) ) 2 ( \frac{π}{2} - a tan \vert \frac{imag ( {B}_{k}^{s} )}{real ( {B}_{k}^{s} )} \vert ) \\ {ϕ}_{Q} = - sgn ( real ( {B}_{k}^{s} ) ) sgn ( imag ( {B}_{k}^{s} ) ) 2 a tan \vert \frac{imag ( {B}_{k}^{s} )}{real ( {B}_{k}^{s} )} \vert \qquad [ Eq . 50 ]$$
And the terms on the righthand side of Equation 49, using the signal-to-interference ratio SIR_{I(Q)} of the I(Q) branch and the tentative decision error probability of the I(Q) branch:
$$g ( {SIR}_{I ( Q )} \vert {h}_{k , l} , {H}_{k , l}^{s} , {b}_{k} , {B}_{k}^{s} ) = \frac{1}{\sqrt{2 π}} {{{\int }^{∞} ⅇ}_{\sqrt{{SIR}_{I ( Q )}}}}^{- \frac{{x}^{2}}{2}} ⅆ x \qquad [ Eq . 51 ]$$
Are expressed as follows:
$$f ( {h}_{k , l} , {H}_{k , l}^{s} , {B}_{k}^{s} , {B}_{k}^{s} ) = ( 1 - g ( {SIR}_{I} \vert {h}_{k , l} , {H}_{k , l}^{s} , {b}_{k} , {B}_{k}^{s} ) ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{I}} , {B}_{k}^{s} ) = g ( {SIR}_{I} \vert {h}_{k , l} , {H}_{k , l}^{s} , {b}_{k} , {B}_{k}^{s} ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{Q}} , {B}_{k}^{s} ) = ( 1 - g ( {SIR}_{I} \vert {h}_{k , l} , {H}_{k , l}^{s} , {b}_{k} , {B}_{k}^{s} ) ) g ( {SIR}_{Q} \vert {h}_{k , l} , {H}_{k , l}^{s} , {b}_{k} , {B}_{k}^{s} ) \\ f ( {h}_{k , l} , {H}_{k , l}^{s} , - {B}_{k}^{s} , {B}_{k}^{s} ) = g ( {SIR}_{I} \vert {h}_{k , l} , {H}_{k , l}^{s} , {b}_{k} , {B}_{k}^{s} ) g ( {SIR}_{Q} \vert {h}_{k , l} , {H}_{k , l}^{s} , {b}_{k} , {B}_{k}^{s} ) . \qquad [ Eq . 52 ]$$

8. A weighting coefficient determining method according to claim 7, wherein said φ_{I} and φ_{Q} are calculated according to the following:
φ_{I}=π−2a tan (β) [Eq. 53]
φ_{Q}=2a tan (β) [Eq. 54]
Where β in the equations is a value calculated based on a power ratio γ between the I and Q branches expressed by the following equation:
$$β = \frac{1}{\sqrt{γ}} . \qquad [ Eq . 55 ]$$

9. A weighting coefficient determining method according to claim 1, characterized in that said digital radio communications are code division multiple access (CDMA) communications.

10. An interference canceller unit in a subtractive interference canceller for digital radio communications wherein the communication channel is composed of pilot bits, other control bits and data bits; comprising
adding means for receiving and adding an interference cancellation residual signal and a replica signal from a previous stage;
despreading means for despreading the aforementioned addition signal by multiplying a spreading code of the user;
correcting means for determining a fading vector and performing transmission path correction;
tentative decision means for deciding on a symbol from the transmission path corrected signal;
weighting means for multiplying a weighting coefficient to the tentative decision symbol;
spreading means for respreading the tentative decision symbol by multiplying the spreading code of the user; and
decorrecting means for determining a replica signal by multiplying the inverse of the transmission path properties to the respread signal; and
wherein said weighting means outputs a weighting coefficient λ_{A}^{Q} of the pilots bits, a weighting coefficient λ_{B}^{Q} of the other control bits and a weighting coefficient λ^{I} of the data bits as separately derived values.

11. An interference canceller unit according to claim 10, wherein said weighting means determines said weighting coefficients λ_{A}^{Q}, λ_{B}^{Q} and λ^{I} for each user and stage based on a tentative decision symbol and an average or instantaneous signal-to-interference ratio SIR.

12. An interference canceller unit according to claim 10, wherein said weighting means derives the weighting coefficients λ^{I} and λ^{Q} of the I branch and Q branch from a tentative decision symbol and a tentative decision error probability density function derived from the signal-to-interference ratios SIR_{I} and SIR_{Q}.

13. An interference canceller unit in a subtractive interference canceller for digital radio communications, comprising
adding means for receiving and adding an interference cancellation residual signal and a replica signal from a previous stage;
despreading means for despreading the aforementioned addition signal by multiplying a spreading code of the user;
correcting means for determining a fading vector and performing transmission path correction;
tentative decision means for deciding on a symbol from the transmission path corrected signal;
weighting means for multiplying a weighting coefficient to the tentative decision symbol;
spreading means for respreading the tentative decision symbol by multiplying the spreading code of the user; and
decorrecting means for determining a replica signal by multiplying the inverse of the transmission path properties to the respread signal; and
wherein said weighting means determines a complex weighting coefficient such as to minimize the power of the interference cancellation residual signal for each channel in each stage.

14. An interference canceller unit according to claim 13, wherein said weighting coefficients are derived based on the relationship expressed by the following equation:
$${λ}_{k , l}^{s} ( {H}_{k , l}^{s} , {B}_{k}^{s} ) = \frac{\int ⅆ {h}_{k , l} \int ⅆ {b}_{k} {h}_{k , l} {b}_{k} f ( {h}_{k , l} , {H}_{k , l}^{s} , {b}_{k} , {B}_{k}^{s} )}{{H}_{k , l}^{s} {B}_{k}^{s}} \qquad [ Eq . 56 ]$$
Wherein λ_{k,l}^{S} denotes the weighting coefficient of the l-th path for the k-th user in the s-th stage;
H_{k,l}^{S} denotes the estimated channel of the l-th path for the k-th user in the s-th stage;
Bₖ^{S} denotes the tentative decision symbol of the k-th user in the s-th stage;
h_{k,l}(t) denotes the channel coefficient of the l-th path for the k-th user;
bₖ denotes the signal received by the k-th user; and
f(h_{k,l}, H_{k,l}^{S}, bₖ, Bₖ^{S}) is a combined tentative decision error probability density function relating to the channel coefficient h_{k,l}, the estimated channel H_{k,l}, the received signal bₖ and the tentative decision symbol Bₖ^{S}.

15. An interference canceller unit according to claim 14, wherein said weighting coefficients are approximated as follows:
$${λ}_{k , l}^{s} ( {H}_{k , l}^{s} , {B}_{k}^{s} ) ≅ \frac{\int ⅆ {b}_{k} {b}_{k} f ( {h}_{k , l} , {H}_{k , l}^{s} , {b}_{k} , {B}_{k}^{s} )}{{B}_{k}^{s}} . \qquad [ Eq . 57 ]$$

16. An interference canceller unit according to claim 15, wherein said weighting coefficients are further determined by taking the received signal bₖ as follows:
$${b}_{k} = {A}_{k}^{s} {ⅇ}^{{ⅈϕ}_{k}^{s}} \qquad [ Eq . 58 ]$$
And using the following relationship:
$$\frac{\int ⅆ {b}_{k} {b}_{k} f ( {h}_{k , l} , {H}_{k , l}^{s} , {b}_{k} , {B}_{k}^{s} )}{{B}_{k}^{s}} = \int ⅆ {b}_{k} {A}_{k}^{s} {ⅇ}^{{ⅈϕ}_{k}^{s}} f ( {h}_{k , l} , {H}_{k , l}^{s} , {b}_{k} , {B}_{k}^{s} ) = f ( {h}_{k , l} , {H}_{k , l}^{s} , {B}_{k}^{s} , {B}_{k}^{s} ) + f ( {h}_{k , l} , {H}_{k , l}^{s} , {ⅇ}^{{ⅈϕ}_{I}} {B}_{k}^{s} , {B}_{k}^{s} ) {ⅇ}^{{ⅈϕ}_{I}} + f ( {h}_{k , l} , {H}_{k , l}^{s} , {ⅇ}^{{ⅈϕ}_{Q}} {B}_{k}^{s} , {B}_{k}^{s} ) {ⅇ}^{{ⅈϕ}_{Q}} - f ( {h}_{k , l} , {H}_{k , l}^{s} , {ⅇ}^{ⅈπ} {B}_{k}^{s} , {B}_{k}^{s} ) \qquad [ Eq . 59 ]$$
Wherein φ_{I} and φ_{Q} are phase errors when only the I or Q phase contains measurement errors, and are expressed as follows:
$${ϕ}_{I} = sgn ( real ( {B}_{k}^{s} ) ) sgn ( imag ( {B}_{k}^{s} ) ) 2 ( \frac{π}{2} - a tan \vert \frac{imag ( {B}_{k}^{s} )}{real ( {B}_{k}^{s} )} \vert ) \\ {ϕ}_{Q} = sgn ( real ( {B}_{k}^{s} ) ) sgn ( imag ( {B}_{k}^{s} ) ) 2 a tan \vert \frac{imag ( {B}_{k}^{s} )}{real ( {B}_{k}^{s} )} \vert \qquad [ Eq . 60 ]$$
And the terms on the righthand side of Equation 59, using the signal-to-interference ratio SIR_{I(Q)} of the I(Q) branch and the tentative decision error probability of the I(Q) branch:
$$g ( {SIR}_{I ( Q )} \vert {h}_{k , l} , {H}_{k , l}^{s} , {b}_{k} , {B}_{k}^{s} ) = \frac{1}{\sqrt{2 π}} {{{\int }^{∞} ⅇ}_{\sqrt{{SIR}_{I ( Q )}}}}^{- \frac{{x}^{2}}{2}} ⅆ x \qquad [ Eq . 61 ]$$
Are expressed as follows:
$$f ( {h}_{k , l} , {H}_{k , l}^{s} , {B}_{k}^{s} , {B}_{k}^{s} ) = ( 1 - g ( {SIR}_{I} \vert {h}_{k , l} , {H}_{k , l}^{s} , {b}_{k} , {B}_{k}^{s} ) ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{I}} , {B}_{k}^{s} ) = g ( {SIR}_{I} \vert {h}_{k , l} , {H}_{k , l}^{s} , {b}_{k} , {B}_{k}^{s} ) ( 1 - g ( {SIR}_{Q} \vert {h}_{k , l} , {H}_{k , l}^{s} , {b}_{k} , {B}_{k}^{s} ) ) \\ f ( {h}_{k , l} , {H}_{k , l}^{s} , {B}_{k}^{s} {ⅇ}^{{ⅈϕ}_{Q}} , {B}_{k}^{s} ) = ( 1 - g ( {SIR}_{I} \vert {h}_{k , l} , {H}_{k , l}^{s} , {b}_{k} , {B}_{k}^{s} ) ) g ( {SIR}_{Q} \vert {h}_{k , l} , {H}_{k , l}^{s} , {b}_{k} , {B}_{k}^{s} ) \\ f ( {h}_{k , l} , {H}_{k , l}^{s} , - {B}_{k}^{s} , {B}_{k}^{s} ) = g ( {SIR}_{I} \vert {h}_{k , l} , {H}_{k , l}^{s} , {b}_{k} , {B}_{k}^{s} ) g ( {SIR}_{Q} \vert {h}_{k , l} , {H}_{k , l}^{s} , {b}_{k} , {B}_{k}^{s} ) . \qquad [ Eq . 62 ]$$

17. An interference canceller unit according to claim 16, wherein said φ_{I} and φ_{Q} are calculated according to the following:
φ_{I}=π−2a tan (β) [Eq. 63 ]
φ_{Q}=2a tan (β) [Eq. 64 ]
Wherein β in the equations is a value calculated based on a power ratio γ between the I and Q branches expressed by the following equation:
$$β = \frac{1}{\sqrt{γ}} . \qquad [ Eq . 65 ]$$

18. An interference canceller unit according to claim 10, wherein said digital radio communications are code division multiple access (CDMA) communications.

19. A parallel subtractive interference canceller comprising a plurality of processing stages composed of a plurality of interference canceller units for handling a plurality of users, each stage aside from the final stage further comprising an adder; wherein
a replica signal is prepared by inputting a received signal and a zero value to each interference canceller unit in the first stage, and outputted to said adder and each interference canceller unit of the corresponding user in the next stage;
a replica signal for each stage from the second stage to the next-to-last stage is prepared by inputting the interference cancellation residual signal in the previous stage and said replica signal of the previous stage to each interference canceller unit, and outputted to said adder and each interference canceller unit of the corresponding user in the next stage; and
a replica signal is prepared in each interference canceller unit of the final stage by inputting the interference cancellation residual signal of the previous stage and said replica signal of the previous stage, and outputted; and
wherein the interference canceller unit of claim 10 is used.

20. A serial subtractive interference canceller comprising a plurality of stages composed of a plurality of interference canceller units for handling a plurality of users; wherein
a replica signal is prepared by inputting a received signal and a zero value to the interference canceller unit of the first user in the first stage and outputted to the interference canceller unit of the corresponding user in the next stage, and the replica signal is subtracted from the received signal and the result is outputted to the interference canceller unit of the second user;
a replica signal is prepared by inputting a signal subtracting replica signals from the first through previous users from the received signal and a zero value to the interference canceller unit of the second and subsequent users of the first stage, outputted to the interference canceller unit of the corresponding user in the next stage, and the replica signal is subtracted from the received signal and the result outputted to the interference canceller unit of the next user;
a replica signal is prepared by inputting an interference cancellation residual signal of the first stage instead of the received signal and the replica signal from the previous stage instead of a zero value to the interference canceller unit of the first user in the second stage, and outputted to the interference canceller unit of the corresponding user in the next stage, and the replica signal is subtracted from the received signal and the result outputted to the interference canceller unit of the second user; and
a replica signal is prepared and outputted by performing the same procedure until the final stage; and
wherein the interference canceller unit of claim 10 is used.

21. A weighting coefficient determining method according to claim 4, characterized in that said digital radio communications are code division multiple access (CDMA) communications.

22. An interference canceller unit according to claim 13, wherein said digital radio communications are code division multiple access (CDMA) communications.

23. A parallel subtractive interference canceller comprising a plurality of processing stages composed of a plurality of interference canceller units for handling a plurality of users, each stage aside from the final stage further comprising an adder; wherein
a replica signal is prepared by inputting a received signal and a zero value to each interference canceller unit in the first stage, and outputted to said adder and each interference canceller unit of the corresponding user in the next stage;
a replica signal for each stage from the second stage to the next-to-last stage is prepared by inputting the interference cancellation residual signal in the previous stage and said replica signal of the previous stage to each interference canceller unit, and outputted to said adder and each interference canceller unit of the corresponding user in the next stage; and
a replica signal is prepared in each interference canceller unit of the final stage by inputting the interference cancellation residual signal of the previous stage and said replica signal of the previous stage, and outputted; and
wherein the interference canceller unit of claim 13 is used.

24. A serial subtractive interference canceller comprising a plurality of stages composed of a plurality of interference canceller units for handling a plurality of users; wherein
a replica signal is prepared by inputting a received signal and a zero value to the interference canceller unit of the first user in the first stage and outputted to the interference canceller unit of the corresponding user in the next stage, and the replica signal is subtracted from the received signal and the result is outputted to the interference canceller unit of the second user;
a replica signal is prepared by inputting a signal subtracting replica signals from the first through previous users from the received signal and a zero value to the interference canceller unit of the second and subsequent users of the first stage, outputted to the interference canceller unit of the corresponding user in the next stage, and the replica signal is subtracted from the received signal and the result outputted to the interference canceller unit of the next user;
a replica signal is prepared by inputting an interference cancellation residual signal of the first stage instead of the received signal and the replica signal from the previous stage instead of a zero value to the interference canceller unit of the first user in the second stage, and outputted to the interference canceller unit of the corresponding user in the next stage, and the replica signal is subtracted from the received signal and the result outputted to the interference canceller unit of the second user; and
a replica signal is prepared and outputted by performing the same procedure until the final stage; and
wherein the interference canceller unit of claim 13 is used.
